(19) United States
(12) Patent Application Publication
(10) Pub. No.: US 2012/0058425 A1
(43) Pub. Date: Mar. 8, 2012

(54) TONER, PREMIX AGENT, AND AGENT CONTAINER

(76) Inventor: Hyo Shu, Kanagawa (JP)

(21) Appl. No.: 13/227,036

(22) Filed: Sep. 7, 2011

(30) Foreign Application Priority Data
Sep. 8, 2010 (JP) 2010-200463

(51) Int. Cl. G03G 9/00; G03G 9/08; G03G 9/16; G03G 9/113; G03G 15/08

(52) U.S. Cl. 430/105; 430/109.4; 430/108.8; 430/137.1; 399/252; 399/262

(57) ABSTRACT

A toner including a release promoter and a binder resin containing crystalline polyester resin and non-crystalline polyester resin, wherein W/R is 0.045 to 0.850 where W denotes height of third bottom peak in infrared absorption spectrum of crystalline polyester resin and R denotes height of maximum top peak in infrared absorption spectrum of non-crystalline polyester resin, each of the infrared absorption spectra being measured by infrared spectroscopic method (KBr method) using Fourier transform infrared spectrometer, wherein the toner is used as toner contained with carrier in premix agent which is developer containing them previously mixed together before shipment, and wherein the premix agent is used in an image forming apparatus containing latent image bearing member, developing device for developing latent image on the latent image bearing member with developer containing toner and carrier, and agent supplying unit configured to supply the premix agent to the developing device.

### BACKGROUND OF THE INVENTION

1. Field of the Invention

The present invention relates to a toner to be contained together with a carrier in a premix agent, which contains the toner and the carrier previously mixed together before shipment. The present invention also relates to a premix agent containing the toner and to an agent container housing the premix agent.

2. Description of the Related Art

In conventionally known image forming apparatuses, a latent image on a latent image bearing member (e.g., a photoconductor) is developed by a developing device housing a developer containing a toner and a carrier and, if necessary, an additional toner is supplied to the developing device. In these image forming apparatuses, the toner concentration of the developer is maintained within a predetermined range by, if necessary, supplying the additional toner to the developer in the developing device whose toner is consumed by development. In the developing device, while the developer is being circulated and conveyed, part of the developer is conveyed to a developing region facing the latent image bearing member, where it contributes to development. In recent years, the amount of the developer housed in the developing device has been made smaller in response to downsizing of the apparatus, and the developer has been made to circulate at high speed in the developing device in response to the requirement of high-speed processing. These attempts increase stress applied to the developer in the developing device to abrade the coated layer of the toner surface. In addition, it has been easier for the carrier in the developer to be degraded due to, for example, adhesion of the components of the toner. In order to form good images for a long period of time by preventing a drop of image quality due to the degraded carrier, it is necessary to regularly replace the carrier in the developer, which requires time and effort for maintenance.

In the image forming apparatus disclosed in view of the above in Japanese Patent Application Laid-Open (JP-A) No. 2009-69800, instead of a toner, a premix agent containing a carrier and a toner previously mixed together is supplied to the developing device to return the toner concentration of the developer, and the extra developer overflows from the developing device. With this configuration, while the old carrier is gradually discharged from the developing device as the developer overflows, a new carrier in the premix agent is supplied to the developer. Through such discharging and supplying, the carrier in the developer is gradually replaced with a new carrier, which can omit regularly-performed replacement of the carrier.

### SUMMARY OF THE INVENTION

In this image forming apparatus, however, the old carrier in the developing device is not totally replaced with a new carrier. Since all of the old carrier cannot be replaced with a new carrier, the old carrier is still present in the developing device. As a result, the charge amount of the toner in the developing device tends to be varied. In particular, at the first print job after long-term suspension of operation, the new carrier rapidly raises the charge amount of the surrounding toner particles but the old carrier gradually raises the charge amount of the surrounding toner particles, causing serious unevenness in charge amount between the toner particles. This makes it difficult to desirably reproduce thin lines.

The present invention has been accomplished under such circumstances, and aims to provide, for example, a toner capable of improving the reproducibility of thin lines.

<1> A toner including:

a binder resin, and

a release promoter,

wherein the binder resin contains at least a crystalline polyester resin and a non-crystalline polyester resin,

wherein a value of W/R is in a range of 0.045 to 0.850 where W denotes a height of a third bottom peak in an infrared absorption spectrum of the crystalline polyester resin and R denotes a height of a maximum top peak in an infrared absorption spectrum of the non-crystalline polyester resin and each of the infrared absorption spectra is measured by an infrared spectroscopic method (KBr method) using a Fourier transform infrared spectrometer,

wherein the toner is used as a toner contained together with a carrier in a premix agent which is a developer containing the toner and the carrier previously mixed together before shipment, and

wherein the premix agent is used in an image forming apparatus which includes:

a latent image bearing member,

a developing device for developing a latent image on the latent image bearing member with the developer containing the toner and the carrier, and

an agent supplying unit configured to supply the premix agent to the developing device.

<2> A premix agent including:

the toner according to <1>, and

a carrier,

wherein the premix agent is a developer containing the toner and the carrier previously mixed together before shipment and is used in an image forming apparatus which includes:

a latent image bearing member,

a developing device for developing a latent image on the latent image bearing member with a developer containing the toner and the carrier, and

an agent supplying unit configured to supply the premix agent to the developing device.

<3> An agent container including:

the premix agent according to <2>,

wherein the agent container is detachably mounted to a main body of an image forming apparatus which includes:

a latent image bearing member,

a developing device for developing a latent image on the latent image bearing member with a developer containing the toner and the carrier,

the agent container, and

an agent supplying unit configured to supply the premix agent contained in the agent container to the developing device.

<4> An image forming apparatus including:

a latent image bearing member,

a developing device for developing a latent image on the latent image bearing member with a developer containing a toner and a carrier,

an agent container detachably mounted to a main body of the image forming apparatus and houses a premix agent which is the developer containing the toner and the carrier previously mixed together before shipment, and

an agent supplying unit configured to supply the premix agent contained in the agent container to the developing device,

wherein the agent container is the agent container according to <3>.

<5> An image forming method including:

developing a latent image on a latent image bearing member with a developing device, and

supplying to the developing device, as a developer, a premix agent containing a toner and a carrier previously mixed together before shipment,

wherein the premix agent is the premix agent according to <2>.

In these inventions, as clarified by the present inventor in the below-described experiments, a ratio W/R, is adjusted to fall within a range of 0.045 to 0.850 to improve the reproducibility of thin lines more than conventional cases. Here, W denotes a height of the third bottom peak in an infrared absorption spectrum of the crystalline polyester resin which is a component of the binder resin contained in the toner; and R denotes a height of a top peak in an infrared absorption spectrum of the non-crystalline polyester resin which is another component of the binder resin contained in the toner.

### BRIEF DESCRIPTION OF THE DRAWINGS

FIG. 1 is one exemplary infrared absorption spectrum of a crystalline polyester resin.

FIG. 2 is one exemplary infrared absorption spectrum of a non-crystalline polyester resin.

FIG. 3 is a schematic view of the configuration of a printer according to an embodiment.

FIG. 4 is a schematic view of a process unit configured to forming a Y toner image in the printer illustrated in FIG. 3.

FIG. 5 is a perspective view of the appearance of the process unit illustrated in FIG. 4.

FIG. 6 is an exploded view of the configuration of the interior of a developing unit of the process unit illustrated in FIG. 4.

FIG. 7 is a perspective view of an agent bottle for Y.

FIG. 8 is a perspective view of the agent (toner) bottle illustrated in FIG. 7 in a state where the toner bottle is separated into a bottle and a holder.

FIG. 9 is a perspective view of an agent supplying device of the printer illustrated in FIG. 3.

FIG. 10 is a schematic view of the toner bottle illustrated in FIG. 7 mounted to the agent supplying device illustrated in FIG. 9 as well as the configuration surrounding the toner bottle.

### DETAILED DESCRIPTION OF THE INVENTION

Next will be described embodiments of, for example, a toner to which the present invention is applied.

A toner of the present invention is a toner including a binder resin and a release promoter,

wherein the binder resin contains at least a crystalline polyester resin and a non-crystalline polyester resin, wherein a value of W/R is in a range of 0.045 to 0.850 where W denotes a height of a third bottom peak in an infrared absorption spectrum of the crystalline polyester resin and R denotes a height of a maximum top peak in an infrared absorption spectrum of the non-crystalline polyester resin and each of the infrared absorption spectra is measured by an infrared spectroscopic method (KBr method) using a Fourier transform infrared spectrometer,

wherein the toner is used as a toner contained together with a carrier in a premix agent which is a developer containing the toner and the carrier previously mixed together before shipment, and

wherein the premix agent is used in an image forming apparatus which includes:

a latent image bearing member,

a developing device for developing a latent image on the latent image bearing member with a developer containing the toner and the carrier,

an agent supplying unit configured to supply the premix agent to the developing device.

In the toner according to the embodiment, the above peak ratio W/R is adjusted to fall within a range of 0.045 to 0.850. The peak ratio W/R is preferably 0.080 to 0.450. When the peak ratio W/R, is smaller than 0.045, a charge controlling agent and toner raw materials are easily localized in a solvent not to be uniformly dispersed in the toner. This is likely to cause a large difference in charge amount between the individual base particles forming a toner, leading to unevenness in charge amount of the resultant toner. Whereas when the peak ratio W/R is greater than 0.850, the crystalline polyester resin is likely to contaminate the carrier to accelerate degradation of the carrier.

The following reason may explain the attainment of desired thin-line reproducibility by adjusting the peak ratio W/R to fall within a range of 0.045 to 0.850. Specifically, the crystalline polyester resin is dispersed in a crystalline state without being dissolved in the non-crystalline polyester resin in the base particles. When the peak ratio W/R falls within a range of 0.045 to 0.850, the crystalline polyester has high affinity to the charge controlling agent and other materials. The crystalline polyester is easily accessible to the charge controlling agent to promote their mutual dispersiblities, whereby they can finely be dispersed in the base particles. As a result, conceivably, the localization of the components between the toner particles is reduced to make uniform the charge amounts of the toner particles as well as increase the charge rising speed of the toner, whereby good thin-line reproducibility is realized. The peak ratio W/R depends on the compatible state between the crystalline polyester resin and the non-crystalline polyester resin. With a quality engineering technique (e.g., the proportion of toner raw materials and emulsification), the peak ratio W/R can be adjusted to fall within a range of 0.045 to 0.850 by well-known techniques. That is, by controlling the compatible state between the crystalline polyester resin and the non-crystalline polyester resin considering variation in quality, the peak ratio W/R can be adjusted to fall within a range of 0.045 to 0.850.

The release promoter is not particularly limited and may be appropriately selected depending on the intended purpose. It is preferably a microcrystalline wax.

In the toner according to the embodiment, the microcrystalline wax used as the release promoter contains C20-C80 hydrocarbons containing a linear hydrocarbon in an amount of 55% by mass to 70% by mass. The average number of carbon atoms (average carbon number) is preferably 50±20. The microcrystalline wax having a small average carbon number improves release promoting property at low temperatures. The microcrystalline wax having a large average carbon number improves anti-aggregation and anti-filming properties. When the average carbon number is less than 20, the penetration degree of the resultant toner becomes excessively large; i.e., the resultant toner becomes too soft, increasing aggregation property of toner particles to easily cause toner filming on, for example, a photoconductor drum, a fixing roller and a fixing film. Whereas when the average carbon number exceeds 80, it is difficult for the microcrystalline wax to be finely dispersed, leading to contamination due to the wax.

The microcrystalline wax preferably has a melting point of 65° C. to 90° C. where the melting point is defined as a maximum endothermic peak temperature measured through differential scanning calorimetry (DSC). When the number of carbon atoms is smaller than 20 or the melting point measured through DSC is lower than 65° C., the wax easily exudes on the surface of the toner to potentially contaminate the carrier. Whereas when the number of carbon atoms is larger than 80 or the melting point measured through DSC is higher than 90° C., the wax is hardly dispersed in the toner, resulting in that the wax tends to be localized in the toner.

The amount of the release promoter contained in the base particles (rate of the release promoter with respect to the total amount of the base particles) is preferably 1% to 20%. When the amount of the release promoter contained therein is less than 1%, the release promoting property expected for the wax is not satisfactory, potentially causing toner offset (toward a fixing roller or other members) during fixing in some cases. Whereas when the amount of the release promoter contained therein exceeds 20%, the wax present on the toner surface contaminates the carrier, potentially accelerating degradation of the carrier; i.e., degradation of charging performance of the carrier.

The endothermic peak temperature of the crystalline polyester resin measured through differential scanning calorimetry (DSC) is preferably 50° C. to 150° C. When the endothermic peak temperature is lower than 50° C., the crystalline polyester resin present on the toner surface contaminates the carrier, potentially accelerating degradation of the carrier; i.e., degradation of charging performance of the carrier. In addition, the crystalline polyester resin present on the toner surface degrades the heat resistance storage stability of the toner, making it easy to form aggregates during the course of storage. As a result, the toner may cause degradation of image quality due to a decrease in flowability. When the endothermic peak temperature exceeds 150° C., the toner materials cannot sufficiently be dispersed in the toner, potentially allowing the materials to be locally dispersed.

The volume average particle diameter (Dv) of the toner is preferably 3.0 μm to 6.0 μm. When the volume average particle diameter is smaller than 3.0 μm, the coverage of the carrier with the toner becomes excessively high, resulting in that the components in the toner particles may contaminate the carrier drastically. Whereas when the volume average particle diameter is greater than 6.0 μm, the particle size distribution of the toner particles becomes broad, resulting in that intended thin-line reproducibility cannot be attained in some cases.

The ratio of the volume average particle diameter of the toner to the number average particle diameter of the toner (i.e., a value calculated by dividing the volume average particle diameter of the toner by the number average particle diameter of the toner) is preferably 1.05 to 1.25.

The volume average particle diameter of the toner is measured with a particle size distribution analyzer for toner particles by the Coulter Counter method. The measurement apparatus employable is “COULTER COUNTER TA II” or “COULTER MULTISIZER II” (these products are of Coulter, Inc.). The measurement method is as follows. First, 0.15 mL of a surfactant (preferably alkylbenzene sulfonate) is added as a dispersing agent into 100 mL to 150 mL of an electrolytic solution. Here, the electrolytic solution is an about 1% by mass NaCl aqueous solution prepared using primary sodium chloride; for example, ISOTON-II (produced by Coulter Corporation) may be used. Next, 220 mg of a measurement sample is added to the resultant aqueous solution. The electrolytic solution in which the sample has been suspended is subjected to dispersion treatment for about 13 min using an ultrasonic dispersion apparatus. The volume and number distributions the toner particles are measured by the above apparatus using an aperture of 100 μm. Based on the distributions obtained, the volume average particle diameter (Dv) and the number average particle diameter (Dn) can be calculated. As channels, the following 13 channels were used, and particles having diameters which are equal to or greater than 2.00 μm but less than 40.30 μm were targeted: a channel of 2.00 μm or greater but less than 2.52 μm; a channel of 2.52 μm or greater but less than 3.17 μm; a channel of 3.17 μm or greater but less than 4.00 μm; a channel of 4.00 μm or greater but less than 5.04 μm; a channel of 5.04 μm or greater but less than 6.35 μm; a channel of 6.35 μm or greater but less than 8.00 μm; a channel of 8.00 μm or greater but less than 10.08 μm; a channel of 10.08 μm or greater but less than 12.70 μm; a channel of 12.70 μm or greater but less than 16.00 μm; a channel of 16.00 μm or greater but less than 20.20 μm; a channel of 20.20 μm or greater but less than 25.40 μm; a channel of 25.40 μm or greater but less than 32.00 μm; and a channel of 32.00 μm or greater but less than 40.30 μm.

In order for the release promoter (microcrystalline wax) to easily exude from the interior to the surface of the toner during fixing, it is important to disperse the crystalline polyester resin and the release promoter in the toner as homogeneously as possible. Since the base particles produced by the polymerization method are superior in homogeneous dispersibility to those produced by the pulverization method, it is preferred that the polymerization method be employed.

The binder resin of the base particles of the toner according to the embodiment contains a crystalline polyester resin (hereinafter referred to as “crystalline polyester (iii).”

The crystalline polyester (iii) is polyester produced through reaction between an alcohol component and an acid component, and having at least a melting point.

Examples of the alcohol component of the crystalline polyester (iii) include C2-C6 diol compounds such as 1,4-butanediol, 1,6-hexanediol and derivatives thereof. Examples of the acid component of the crystalline polyester (iii) include maleic acid, fumaric acid, succinic acid and derivatives thereof. The crystalline polyester (iii) has a structural repeating unit represented by the following Chemical Formula and synthesized from the above alcohol component and the above acid component.

O—CO—CR₁═CR₂—CO—O—(CH₂)_{D}

where R₁ and R₂ each represent a hydrogen atom or a hydrocarbon group having 1 to 20 carbon atoms; and n is a natural number.

Examples of the method for controlling the crystallinity and softening point of the crystalline polyester (iii) include a method in which the molecule of non-linear polyesters or the like is appropriately designed. The non-linear polyester can be synthesized through condensation polymerization between the alcohol component additionally containing a tri or higher polyhydric alcohol (e.g., glycerin) and the acid component additionally containing a tri or higher polycarboxylic acid (e.g., trimellitic anhydride).

The molecular structure of the crystalline polyester (iii) can be confirmed through, for example, solid NMR. As a result of the extensive studies conducted in view that a crystalline polyester having a sharp molecular weight distribution and a low molecular weight is excellent in low-temperature fixing property, the molecular weight of the crystalline polyester (iii) is preferably adjusted as follows. Specifically, in a molecular weight distribution diagram obtained through GPC of the soluble matter of a sample in o-dichlorobenzene where the horizontal axis indicates log(M) and the vertical axis indicates % by mass, preferably, the peak is in the range of 3.5 to 4.0 and the half width of the peak is 1.5 or less. In addition, the weight average molecular weight (Mw) is 1,000 to 6,500, the number average molecular weight (Mn) is 500 to 2,000, and the Mw/Mn is 2 to 5.

The average dispersion particle diameter of the crystalline polyester (iii) in the base particles is preferably 0.2 μm to 3.0 μm as the diameter of the major axes. When the diameter of the major axes is adjusted so as to fall the range of 0.2 μm to 3.0 μm, the specific microcrystalline wax can be finely dispersed in the base particles. As a result, the wax can be prevented from being localized in the surfaces of the base particles.

The acid value of the crystalline polyester (iii) is preferably 8 mgKOHJg to 45 mgKOH/g. This is because, in order to attain desired low-temperature fixing property in terms of compatibility between paper and the crystalline polyester, the acid value thereof is preferably 8 mgKOH/g or higher, more preferably 20 mgKOH/g or higher, and also, in order to improve hot offset property, the acid value thereof is preferably 45 mgKOH/g or lower.

Also, the hydroxyl value of the crystalline polyester (iii) is preferably 0 mgKOH/g to 50 mgKOH/g, more preferably 5 mgKOH/g to 50 mgKOH/g, in order to attain desired low-temperature fixing property and excellent charging property.

The binder resin contains a non-crystalline polyester resin.

The molecular structure of the non-crystalline polyester resin is not particularly limited so long as it has a non-crystalline structure. The non-crystalline polyester resin employable is non-crystalline polyesters having various structures which are commonly used as a binder resin for toner. Examples of the non-crystalline polyesters include those having, in the main chains of the molecules, an ester bond represented by the following General Formula (1) in an amount of at least 60 mol %.

—OOC—R¹—COO—R²— (1)

In General Formula (1), R¹ and R² each represent a divalent hydrocarbon group having 2 to 20 carbon atoms.

The divalent hydrocarbon group represented by R¹ is not particularly limited so long as it gives a non-crystalline polyester resin. This hydrocarbon group includes aliphatic or aromatic divalent hydrocarbon groups. The aliphatic divalent hydrocarbon group includes alkylene groups each having 2 to 20 carbon atoms, preferably 2 to 14 carbon atoms; and cycloalkylene groups each having 4 to 12 carbon atoms, preferably 6 to 8 carbon atoms. The aromatic divalent hydrocarbon group includes arylene groups each having 6 to 14 carbon atoms, preferably 6 to 12 carbon atoms; and arylene dialkylene groups each having 8 to 12 carbon atoms.

The divalent hydrocarbon group represented by R¹ is a divalent carboxylic acid residue. In the present invention, particularly preferred are residues derived from divalent carboxylic acids such as fumaric acid, terephthalic acid, adipic acid and dodecenyl succinic anhydride.

R² represents a divalent alcohol residue including residues derived from conventionally known aliphatic or aromatic divalent alcohols. Specific examples of the divalent alcohol residue include residues derived from aliphatic diols such as alkylene diols having 2 to 14 carbon atoms, preferably 2 to 12 carbon atoms; and cycloalkylenediols having 5 to 14 carbon atoms, preferably 6 to 8 carbon atoms.

Also, the divalent alcohol residue includes residues derived from arylenedialkylenediols having 8 to 18 carbon atoms, preferably 8 to 15 carbon atoms; and residues derived from a diol represented by the following General Formula (3):

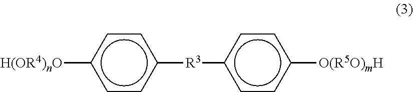

In General Formula (3), R³ represents an alkylene group having 1 to 6 carbon atoms; R⁴ and R⁵ each represent an alkylene group having 2 to 4 carbon atoms; each of n and m is an integer of 1 to 16, preferably 2 to 14.

Examples of the dihydric alcohol (diol) represented by General Formula (3) include a propylene oxide adduct of bisphenol A and an ethylene oxide adduct of bisphenol A.

The polyester contained in the binder resin (toner binder) preferably has a molecular weight peak of 1,000 to 30,000, a component having a molecular weight of 30,000 or higher in an amount of 1% by mass to 80% by mass, and a number average molecular weight of 2,000 to 15,000, in the molecular weight distribution of THF soluble matter thereof. Also, the polyester preferably contains a component having a molecular weight of 1,000 or lower in an amount of 0.1% by mass to 5.0% by mass in the molecular weight distribution of THF soluble matter of the polyester contained in the binder resin. In addition, the polyester contained in the binder resin preferably contains THF insoluble matter in an amount of 1% by mass to 15% by mass.

The above toner may contain a colorant.

The colorant used is a known dye or pigment. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower, lithopone and mixtures thereof. The amount of the colorant contained in the toner is preferably 1% by mass to 15% by mass, more preferably 3% by mass to 10% by mass.

If necessary, the toner may contain a charge controlling agent. The charge controlling agent may be a known charge controlling agent. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine active agents, metal salts of salicylic acid, and metal salts of salicylic acid derivatives. Specific examples thereof include nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (these products are of ORIENT CHEMICAL INDUSTRIES CO., LTD), quaternary ammonium salt molybdenum complex TP-302 and TP-415 (these products are of Hodogaya Chemical), quaternary ammonium salt COPY CHARGE PSY VP 2038, triphenylmethane derivative COPY BLUE PR, quaternary ammonium salt COPY CHARGE NEG VP2036 and COPY CHARGE NX VP434 (these products are of Hoechst AG), LRA-901 and boron complex LR-147 (these products are of Japan Carlit), copper phthalocyanine, perylene, quinacridone, azo pigments, and polymeric compounds having, as a functional group, a sulfonic acid group, carboxyl group, quaternary ammonium salt, etc.

The charge controlling agent used is not flatly determined and is varied depending on the type of the binder resin used, on an optionally used additive, and on the toner production method used (including the dispersion method used). The amount of the charge controlling agent is preferably about 0.1 parts by mass to about 10 parts by mass, more preferably about 0.2 parts by mass to about 5 parts by mass, per 100 parts by mass of the binder resin. When the amount of the charge controlling agent is more than 10 parts by mass, the formed toner has too high chargeability, resulting in that the charge controlling agent exhibits reduced effects. As a result, the electrostatic force increases between the developing roller and the toner, decreasing the fluidity of the toner and forming an image with reduced color density. The charge controlling agent may be melt-kneaded together with a masterbatch or resin before dissolution or dispersion. Alternatively, it may be directly added at the time when other toner components are dissolved or dispersed in an organic solvent at the preparation step of a toner material liquid (oil phase). Furthermore, after the formation of the base particles, it may be fixed on the surfaces of the base particles.

Fine resin particles may be used as core materials of the base particles. The fine resin particles can improve dispersion stability and allow the formed toner to have a narrow particle size distribution. The fine resin particles used as the core materials may be any resin, so long as they can form desired aqueous dispersoids when a toner material liquid (oil phase), which has been obtained by dissolving or dispersing in an organic solvent toner materials containing at least a binder resin and/or a binder resin precursor, preferably a release promoter, is emulsified or dispersed in an aqueous medium (aqueous phase). The fine resin particles may be a thermoplastic resin or a thermosetting resin. Examples thereof include vinyl resins, polyurethans, epoxy resins, polyesters, polyamides, polyimides, silicon-containing resins, phenol resins, melamine resins, urea resins, aniline resins, ionomer resins and polycarbonates. These may be used alone or in combination. Among them, preferred are vinyl resins, polyurethans, epoxy resins, polyesters and mixtures thereof, from the viewpoint of easily obtaining aqueous dispersoids of fine spherical resin particles. The vinyl resin is a polymer produced through homopolymerization or copolymerization of vinyl monomers. Examples of the vinyl resin include styrene-(meth)acylate resins, styrene-butadiene copolymers, (meth)acrylic acid-acrylate polymers, styrene-acrylonitrile copolymers, styrene-maleic anhydride copolymers and styrene-(meth)acrylic acid copolymers. The volume average particle diameter of the fine resin particles is preferably 5 nm to 500 nm.

The above toner preferably contains the base particles formed of particles (colored particles) which are granulated through, for example, desolvation of an emulsion or dispersion liquid of the toner material liquid (oil phase) in the aqueous medium (aqueous phase). Here, in order to improve flowability, developability, chargeability and cleanability of the toner containing the base particles, an external additive may be added and attached onto the surfaces of the base particles. Fine inorganic particles are preferably used as an external additive for promoting flowability, developability and chargeability of the base particles. The primary particle diameter of the fine inorganic particles is preferably 5 nm to 2 μm, particularly preferably 5 nm to 500 nm. Also, the specific surface area of the toner containing the base particles measured by the BET method is preferably 20 m²/g to 500 m²/g. The amount of the fine inorganic particles used is preferably 0.01% by mass to 5% by mass, more preferably 0.01% by mass to 2.0% by mass, with respect to the toner. Specific examples of the fine inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. In addition, fine polymer particles may be used. Examples of the fine polymer particles include polystyrenes obtained through, for example, soap-free emulsion polymerization, suspension polymerization or dispersion polymerization; methacrylate copolymers and acrylate copolymers; polycondensates such as silicone, benzoguanamine and Nylon; and polymer particles of thermosetting resins.

If necessary, the toner particles may be subjected to a surface treatment using a fluidizing agent. By increasing the hydrophobicity of the toner particles through this surface treatment, their flowability and charging property can be prevented from being degraded even under high-humidity conditions. Examples of preferred surface treatment agents include silane coupling agents, silylating agents, fluorinated alkyl group-containing silane coupling agents, organic titanate-containing coupling agents, aluminum-containing coupling agents, silicone oil and modified silicone oil.

The toner according to the embodiment is produced through, for example, a process including a step of preparing a toner material liquid (oil phase) by dissolving or dispersing in an organic solvent materials containing at least a binder resin and/or a binder resin precursor; adding the toner material liquid to an aqueous medium (aqueous phase) for emulsifying or dispersing to prepare an emulsion or dispersion liquid; and removing (desolvating) the organic solvent from the emulsion or dispersion liquid to form base particles. Next will be described one exemplary method for producing the toner according to the present invention. Employable production methods should not be construed as being limited thereto.

The binder resin used is a modified polyester containing at least an ester bond and a binding unit other than the ester bond. The binder resin precursor is a resin precursor capable of producing the modified polyester. The binder resin precursor is preferably a precursor containing a compound having an active hydrogen group and a polyester having a functional group reactive with the active hydrogen group of the compound. For example, when an isocyanate group-containing polyester [polyester prepolymer (A)] is used as the polyester having a functional group reactive with the active hydrogen group, the following production method can be employed.

Specifically, a polyol (1) and a polycarboxylic acid (2) are allowed to react together under heating to 150° C. to 280° C. in the presence of a known esterification catalyst such as tetrabutoxytitanate or dibutyltinoxide, optionally while the pressure is being reduced as appropriate. Then, water is removed to obtain a polyester having a hydroxyl group. Subsequently, the obtained polyester is reacted with a polyisocyanate (3) at 40° C. to 140° C. to obtain an isocyanate group-contianing polyester prepolymer (A) (hereinafter may be abbreviated as “prepolymer (A)”). Further, the thus-obtained prepolymer (A) is reacted at 0° C. to 140° C. with an amine (B) which is a compound having an active hydrogen group, to thereby obtain a polyester modified with a urea bond.

Examples of the polyol (1) include alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the above-listed alicyclic diols with alkylene oxides (e.g., ethylene oxide, propylene oxide and butylene oxide); and adducts of the above-listed bisphenols with alkylene oxides (e.g., ethylene oxide, propylene oxide and butylene oxide). These may be used alone or in combination. Among them, preferred are C2-C12 alkylene glycols and adducts of the bisphenols with alkylene oxides (e.g., bisphenol A ethylene oxide 2 mol adduct, bisphenol A propylene oxide 2 mol adduct and bisphenol A propylene oxide 3 mol adduct).

Examples of the trihydric or higher polyol in the polyol include polyvalent aliphatic alcohols (e.g., glycerin, trimethylolethane, trimethylolpropane, pentaerythritol and sorbitol); trihydric or higher phenols (e.g., phenol novolak and cresol novolak); and adducts of trihydric or higher polyphenols with alkylene oxides. These may be used alone or in combination.

Examples of the polycarboxylic acid (2) include alkylene dicarboxylic acids (e.g., succinic acid, adipic acid and sebacic acid); alkenylene dicarboxylic acids (e.g., maleic acid and fumaric acid); and aromatic dicarboxylic acids (e.g., terephthalic acid, isophthalic acid and naphthalene dicarboxylic acid). These may be used alone or in combination. Among them, preferred are C4-C20 alkenylene dicarboxylic acids and C8-C20 aromatic dicarboxylic acids.

Examples of the trihydric or higher polycarboxylic acid in the polycarboxylic acid (2) include C9-C20 aromatic polycarboxylic acid (e.g., trimellitic acid and pyromellitic acid). These may be used alone or in combination. Notably, instead of the polycarboxylic acid, polycarboxylic anhydrides or lower alkyl esters (e.g., methyl ester, ethyl ester and isopropyl ester) may be used.

Examples of the polyisocyanate (3) include aliphatic polyisocyanates (e.g., tetramethylene diisocyanate, hexamethylene diisocyanate and 2,6-diisocyanatomethylcaproate), alicyclic polyisocyanates (e.g., isophoron diisocyanate and cyclohexylmethane diisocyanate), aromatic diisocyanates (e.g., tolylene diisocyanate and diphenylmethane diisocyanate), aromatic aliphatic diisocyanates (e.g., α,α,α′,α′-tetramethylxylylene diisocyanate), isocyanurates, and blocked products of the above polyisocyanates with a phenol derivative, oxime, caprolactam, etc. These may be used in combination.

Examples of the amine (B) include diamines, tri- or more-valent polyamines, amino alcohols, aminomercaptans, amino acids, and amino-blocked products of these amines. These may be used alone or in combination.

A solvent is optionally used in reacting the polyisocyanate (3) or reacting the prepolymer (A) with the amine (B). Examples of the solvent usable include solvents inert with respect to the polyisocyanate (3), such as aromatic solvents (e.g., toluene and xylene), ketones (e.g., acetone, methyl ethyl ketone and methyl isobutyl ketone), esters (e.g., ethyl acetate), amides (e.g., dimethylformamide and dimethylacetamide) and ethers (e.g., tetrahydrofuran).

When a polyester having undergone no modification (unmodified polyester (ii)) is used in combination, the unmodified polyester (ii) is produced in the same manner as in the production of the polyester having a hydroxyl group and then dissolved in a solution obtained after completion of reaction of the prepolymer (A), followed by mixing.

The aforementioned aqueous medium (aqueous phase) may be water alone or a combination of water and a water-miscible solvent. Examples of the water-miscible solvent include alcohols (e.g., methanol, isopropanol and ethylene glycol), dimethylformamide, tetrahydrofuran, cellosolves (e.g., methyl cellosolve) and lower ketones (e.g., acetone and methyl ethyl ketone). Also, the aqueous medium (aqueous phase) may contain a dispersing agent such as a surfactant or polymeric protective colloid described below.

When the isocyanate group-containing polyester (polyester prepolymer (A)) and the amine (B) are used as the binder resin precursor for forming the base particles, the polyester prepolymer (A) and the amine (B) may be reacted together in the aqueous medium to form a modified polyester (a urea-modified polyester: modified polyester (i)). Alternatively, the polyester prepolymer (A) and the amine (B) may be reacted together in advance to form a modified polyester (a urea-modified polyester: modified polyester (i)).

The method for stably forming, in the aqueous medium, dispersoids formed of the urea-modified polyester (modified polyester (i)) or polyester prepolymer (A) and the amine (B) is, for example, a method in which a composition of toner materials (raw materials) containing the modified polyester (i) or the prepolymer (A), the amine (B), other binder resins (e.g., the above crystalline polyester resin) and a release promoter is added to the aqueous medium, followed by dispersing through application of shearing force.

The polyester prepolymer (A) may be mixed with other toner components (hereinafter referred to as “toner raw materials”) such as a colorant (or a colorant masterbatch), a release promoter, the above crystalline polyester resin, the above unmodified polyester and the above charge controlling agent when forming dispersoids in an aqueous medium. Preferably, the toner raw materials are previously mixed together and then the resultant mixture is dispersed in an aqueous medium.

Also, toner raw materials such as a colorant and a charge controlling agent are not necessarily added to an aqueous medium before particle formation. These toner raw materials may be added thereto after particle formation. For example, after particles containing no colorant are formed, a colorant may be added to the obtained particles with a known dying method.

The dispersion method is not particularly limited and may use a low-speed shearing disperser, a high-speed shearing disperser, a friction disperser, a high-pressure jetting disperser or an ultrasonic disperser. The method using a high-speed shearing disperser is preferably employed since the dispersoids can be dispersed so as to have a particle diameter of 2 μm to 20 μm. In use of the high-speed shearing disperser, the rotating speed is not particularly limited and is generally 1,000 rpm to 30,000 rpm, preferably 5,000 rpm to 20,000 rpm. The dispersion time is generally 0.1 min to 5 min when a batch method is employed. The temperature during dispersion is generally 0° C. to 150° C. (in a pressurized state), preferably from 40° C. to 98° C. The temperature is preferably higher, since the dispersion formed of the urea-modified polyester (modified polyester (i)) and the polyester prepolymer (A) has a lower viscosity and thus can be readily dispersed.

The amount of the aqueous medium used per 100 parts by mass of the toner materials (toner composition) including the modified polyester resin (i), the polyester prepolymer (A) and the amine (B) is generally 50 parts by mass to 2,000 parts by mass, preferably 100 parts by mass to 1,000 parts by mass. When the amount the aqueous medium used is less than 50 parts by mass, the toner composition cannot be sufficiently dispersed, resulting in failure to form toner particles having a predetermined particle diameter. Meanwhile, use of the aqueous medium more than 2,000 parts by mass is economically disadvantageous.

If necessary, a dispersant may be used as described above. Use of the dispersant is preferred from the viewpoints of attaining a sharp particle size distribution and realizing a stable dispersion state.

In the step of synthesizing the urea-modified polyester (modified polyester (i)) from the polyester prepolymer (A) and the amine (B), the amine (B) may be previously added to the aqueous medium, and then the toner material liquid containing the polyester prepolymer (A) (oil phase) may be dispersed for reaction in the aqueous medium. Alternatively, the toner material liquid containing the polyester prepolymer (A) (oil phase) may be added to the aqueous medium and then the amine (B) may be added to the aqueous medium (so that reaction occurs from the interfaces between particles). In this case, the urea-modified polyester is formed preferentially in the surfaces of the formed base particles. As a result, the concentration gradient can be formed in each particle.

A surfactant may be used as a dispersing agent for emulsifying or dispersing, in an aqueous liquid (aqueous medium: aqueous phase), a toner material liquid containing the toner materials (toner composition) dispersed therein (oil phase).

Examples of the surfactant include anionic surfactants such as alkylbenzenesulfonic acid salts, a-olefin sulfonic acid salts and phosphoric acid esters; cationic surfactants such as amine salts (e.g., alkyl amine salts, aminoalcohol fatty acid derivatives, polyamine fatty acid derivatives and imidazoline) and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, use of a fluoroalkyl group-containing surfactant can provide advantageous effects even in a considerably small amount. Examples of fluoroalkyl group-containing anionic surfactants preferably used include fluoroalkyl carboxylic acids having 2 to 10 carbon atoms and metal salts thereof, disodium perfluorooctanesulfonylglutamate, sodium 3-[omega-fluoroalkyl(C6 to C11)oxy)-1-alkyl(C3 or C4) sulfonates, sodium 3-[omega-fluoroalkanoyl(C6 to C8)-N-ethylamino]-1-propanesulfonates, fluoroalkyl(C 11 to C20) carboxylic acids and metal salts thereof, perfluoroalkylcarboxylic acids(C7 to C13) and metal salts thereof, perfluoroalkyl(C4 to C12)sulfonate and metal salts thereof, perfluorooctanesulfonic acid diethanol amide, N-propyl-N-(2-hydroxyethyl)perfluorooctanesulfone amide, perfluoroalkyl(C6 to C10)sulfoneamidepropyltrimethylammonium salts, salts of perfluoroalkyl(C6 to C10)-N-ethylsulfonylglycin and monoperfluoroalkyl(C6 to C16) ethylphosphates. Examples of commercially available products thereof include SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of DIC, Inc.); EFTOP EF-102, 103, 104, 105, 112, 123A, 123B, 306A, 501, 201 and 204 (these products are of Tohchem Products Co., Ltd.); and FUTARGENT F-100 and F150 (these products are of NEOS COMPANY LIMITED).

Examples of the cationic surfactants include fluoroalkyl group-containing primary, secondary or tertiary aliphatic amine acids, aliphatic quaternary ammonium salts (e.g., perfluoroalkyl(C6 to C10)sulfoneamide propyltrimethylammonium salts), benzalkonium salts, benzetonium chloride, pyridinium salts and imidazolinium salts. Examples of commercially available products of thereof include SURFLON S-121 (product of Asahi Glass Co., Ltd.); FRORARD FC-135 (product of Sumitomo 3M Ltd.); UNIDYNE DS-202 (product of Daikin Industries, Ltd.); MEGAFACE F-150 and F-824 (these products are of DIC, Inc.); EFTOP EF-132 (product of Tohchem Products Co., Ltd.); and FUTARGENT F-300 (product of Neos COMPANY LIMITED).

In addition, poorly water-soluble inorganic dispersing agents may be used. Examples of the poorly water-soluble inorganic dispersing agents usable include tricalcium phosphate, calcium carbonate, titanium oxide, colloidal silica and hydroxyapatite. Further, a polymeric protective colloid may be used to stabilize liquid droplets.

Examples of the polymeric protective colloid include homopolymers and copolymers prepared using acids (e.g., acrylic acid, methacrylic acid, α-cyanoacrylic acid, α-cyanomethacrylic acid, itaconic acid, crotonic acid, fumaric acid, maleic acid and maleic anhydride), hydroxyl group-containing (meth)acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide), vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate), acrylamide, methacrylamide, diacetoneacrylamide and methylol compounds of them; acid chlorides (e.g., acrylic acid chloride and methacrylic acid chloride) and nitrogen-containing compounds and nitrogen-containing heterocyclic compounds (e.g., vinyl pyridine, vinyl pyrrolidone, vinyl imidazole and ethyleneimine); polyoxyethylenes (e.g., polyoxyethylenes, polyoxypropylenes, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose).

When an acid- or alkali-soluble compound (e.g., calcium phosphate) is used as a dispersion stabilizer, the calcium phosphate used is dissolved with an acid (e.g., hydrochloric acid), followed by washing with water, to thereby remove it from the formed fine particles. Also, the calcium phosphate may be removed through enzymatic decomposition. Alternatively, the dispersing agent used may remain on the surfaces of the base particles. However, the dispersing agent is preferably removed through washing after elongation and/or crosslinking reaction of the prepolymer (A) in terms of chargeability of the formed toner.

In order to decrease the viscosity of the toner material liquid (oil phase) containing the toner materials (toner composition) dissolved or dispersed therein, a solvent capable of dissolving the modified polyester (i) and the prepolymer (A) may be additionally used. Use of such a solvent is preferred since a sharp particle size distribution can be attained. The solvent used is preferably a volatile solvent having a boiling point lower than 100° C. from the viewpoint of easily removing the solvent. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination. Among them, the solvent is preferably an aromatic solvent such as toluene or xylene; or a halogenated hydrocarbon such as methylene chloride, 1,2-dichloroethane, chloroform or carbon tetrachloride. The amount of the solvent used per 100 parts by mass of the polyester prepolymer (A) is generally 0 parts by mass to 300 parts by mass, preferably 0 parts by mass to 100 parts by mass, more preferably 25 parts by mass to 70 parts by mass. When the solvent is used, the solvent is preferably removed with heating under normal or reduced pressure after completion of elongation and/or crosslinking reaction of the prepolymer (A).

The time of the elongation, crosslinking or crosslinking of elongation-crosslinking reaction of the polyester prepolymer (A) is appropriately selected depending on, for example, reactivity between the isocyanate group-containing moiety of the polyester prepolymer (A) and the amine (B), and is generally 10 min to 40 hours, preferably 2 hours to 24 hours. The reaction temperature is generally 0° C. to 150° C., preferably 40° C. to 98° C. If necessary, a known catalyst may be used in the reaction. Specific examples of the catalyst include dibutyltinlaurate and dioctyltinlaurate.

For removing the organic solvent from the emulsion or dispersion liquid obtained by emulsifying or dispersing the toner material liquid (oil phase) in the aqueous medium (aqueous phase), there can be employed a method in which the entire system is gradually increased in temperature to completely evaporate off the organic solvent contained in the liquid droplets. Alternatively, there can be employed a method in which the emulsion or dispersion liquid is sprayed toward a dry atmosphere, to thereby completely evaporate off the water-insoluble organic solvent contained in the liquid droplets to form fine particles of base particles as well as evaporate off the aqueous dispersing agent. The dry atmosphere toward which the emulsion or dispersion liquid is sprayed generally uses heated gas (e.g., air, nitrogen, carbon dioxide and combustion gas), especially, gas flow heated to a temperature equal to or higher than the highest boiling point of the solvents used. Treatments performed even in a short time using, for example, a spray dryer, a belt dryer or a rotary kiln allow the resultant product to have satisfactory quality.

Even when the dispersoids having a broad particle size distribution are obtained during emulsifying or dispersing and are then subjected to washing and drying while the particle size distribution is being maintained, the dispersoids may be classified so as to have a desired particle size distribution. Examples of the classification method include a method in which fine particles of unnecessary size are removed with, for example, a cyclone, a decanter or a centrifuge. The classification may be performed in the form of powder after drying, but is preferably performed in liquid in terms of efficiency. The classified fine or coarse particles of unnecessary size may be returned to the kneading step where they may be used for particle formation. Here, the fine or coarse particles may be in a wet or dry state. The dispersing agent used is preferably removed from the obtained dispersion liquid to the greatest extent possible. The removal of the dispersing agent is preferably performed simultaneously with the classification.

The obtained powder after drying (base particles) is optionally mixed with foreign particles such as fine particles of the release promoter, charge-controllable fine particles, fine particles of the fluidizing agent and colorant fine particles, followed by application of mechanical impact, to thereby obtain a toner formed of base particles. The application of mechanical impact can prevent the foreign particles from being exfoliated from the surfaces of the obtained toner particles containing base particles (complex particles).

Examples of the specific method for applying mechanical impact include a method in which an impact is applied to a mixture using a high-speed rotating blade and a method in which a mixture is caused to pass through a high-speed airflow for acceleration and aggregated particles or complex particles are crushed against an appropriate collision plate. Examples of apparatuses used in these methods include ONGMILL (product of Hosokawa Micron Corp.), an apparatus produced by modifying an I-type mill (product of Nippon Neumatic Co., Ltd.) so that the pulverizing air pressure thereof is decreased, Hybridization System (product of Nara Machinery Co., Ltd.), CRYPTRON SYSTEM (production of Kawasaki Heavy Industries, Ltd.) and an automatic mortar.

When the toner and the carrier are used to obtain a developer, the amount of the toner is preferably 1 part by mass to 10 parts by mass per 100 parts by mass of the carrier.

The carrier used is, for example, a magnetic carrier.

The magnetic carrier may be a conventionally known carrier such as iron powder, ferrite powder, magnetite powder or magnetic resin carrier each having an average particle diameter of about 20 μm to about 200 μm.

Examples of coating materials of the magnetic carrier include amino-based resins such as urea-formaldehyde resins, melamine resins, benzoguanamine resins, urea resins, polyamide resins and epoxy resins. Further examples include polyvinyl- or polyvinylidene-based resins such as acryl resins, polymethyl methacrylate resins, polyacrylonitrile resins, polyvinyl acetate resins, polyvinyl alcohol resins and polyvinyl butyral resins; polystyrene-based resins such as polystyrene resins and styrene-acryl copolymer resins; halogenated olefin resins such as polyvinyl chloride; polyester-based resins such as polyethylene terephthalate resins and polybutyrene terephthalate resins; polycarbonate-based resins, polyethylene resins, polyvinyl fluoride resins, polyvinylidene fluoride resins, polytrifluoroethylene resins, polyhexafluoropropylene resins, copolymers of vinylidene fluoride and an acryl monomer, copolymers of vinylidene fluoride and vinyl fluoride, fluoroterpolymers of tetrafluoroethylene, vinylidene fluoride and a non-fluorinated monomer; and silicone resins.

If necessary, conductive powder, etc. may be incorporated into the coating resin. The conductive powder usable is, preferably, metal powder, carbon black, titanium oxide, tin oxide and zinc oxide. The average particle diameter of the conductive powder is preferably 1μm or lower. When the average particle diameter exceeds 1 μm, it is difficult to control electrical resistance. Also, the toner of the present invention may be used as a one-component developer using no carrier (magnetic toner or non-magnetic toner).

A premix agent of the present invention includes the toner of the present invention,

wherein the premix agent is a developer containing the toner and a carrier previously mixed together before shipment and is used in an image forming apparatus which includes:

a latent image bearing member,

a developing device for developing a latent image on the latent image bearing member with a developer containing the toner and the carrier,

an agent supplying unit configured to supply the premix agent to the developing device.

An agent container of the present invention includes the premix agent of the present invention which is a developer containing a toner and a carrier previously mixed together before shipment,

wherein the agent container is detachably mounted to a main body of an image forming apparatus which includes:

a latent image bearing member,

a developing device for developing a latent image on the latent image bearing member with a developer containing the toner and the carrier,

the agent container, and

an agent supplying unit configured to supply the premix agent contained in the agent container to the developing device.

An image forming apparatus of the present invention includes:

a latent image bearing member,

a developing device for developing a latent image on the latent image bearing member with a developer containing a toner and a carrier,

an agent container detachably mounted to a main body of the image forming apparatus and houses a premix agent which is the developer containing the toner and the carrier previously mixed together before shipment, and

an agent supplying unit configured to supply the premix agent contained in the agent container to the developing device,

wherein the agent container is the agent container of the present invention.

An image forming method of the present invention includes:

developing a latent image on a latent image bearing member with a developing device, and

supplying to the developing device, as a developer, a premix agent containing a toner and a carrier previously mixed together before shipment,

wherein the premix agent is the premix agent of the present invention.

Next, description will be given to an embodiment in which the present invention is applied to an electrophotographic printer (hereinafter referred to simply as “printer”) serving as an image forming apparatus.

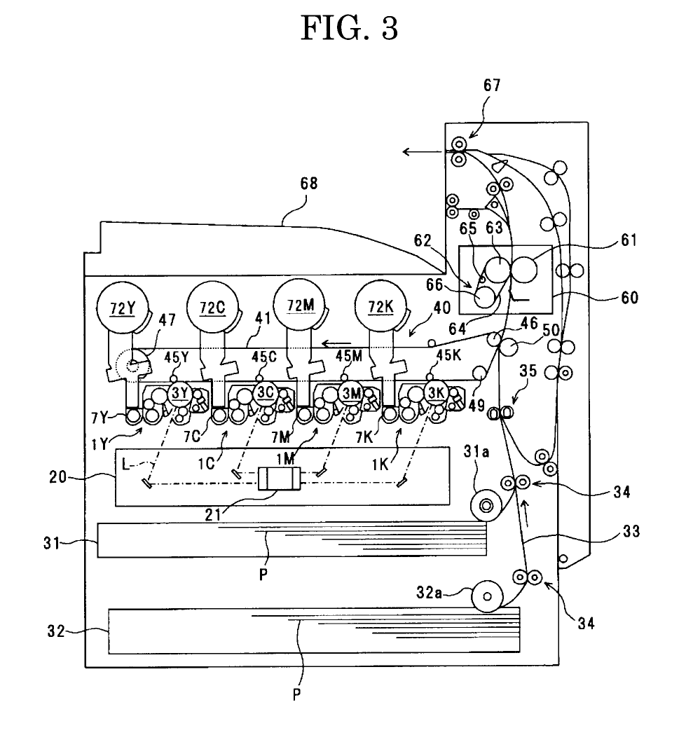

FIG. 3 is a schematic view of the configuration of a printer according to the embodiment. This printer has four process units 1Y, 1C, 1M and 1K for yellow, cyan, magenta and black (hereinafter abbreviated respectively as Y, C, M and K). The process units have the same configuration except that they use different color toners; i.e., Y, C, M or K, as an image forming material.

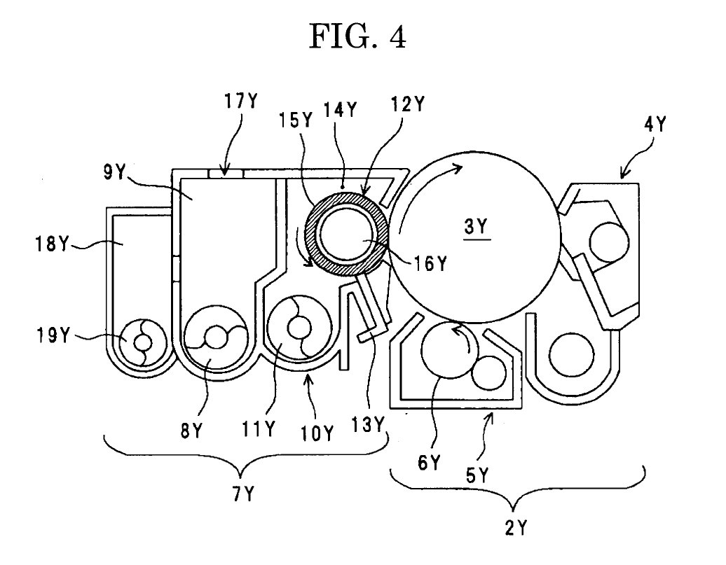

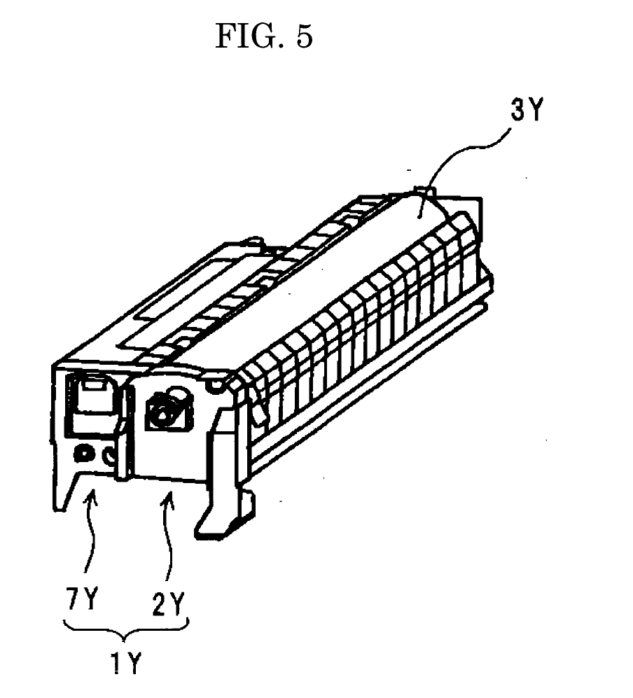

FIG. 4 is a schematic view of the configuration of the process unit 1Y for forming a Y toner image. FIG. 5 is a perspective view of the appearance of the process unit 1Y. In these figures, the process unit 1Y has a photoconductor unit 2Y and a developing unit 7Y. As illustrated in FIG. 5, the photoconductor unit 2Y and the developing unit 7Y are detachably mounted as a single piece of the process unit 1Y to the main body of the printer. In the state where the process unit 1Y is taken out from the main body of the printer, the developing unit 7Y is detachably mountable to a photoconductor unit.

The photoconductor unit 2Y includes, for example, a drum-shaped photoconductor (latent image bearing member) 3Y serving as a latent image bearing member, a drum-shaped cleaning device 4Y, a charge-eliminating device and a charging device 5Y. The charging device 5Y serving as a charging unit has a charging roller 6Y which uniformly charges the surface of the photoconductor 3Y rotated by a driving unit clockwise in FIG. 4. Specifically, in FIG. 4, a charging bias is applied from a power source to the charging roller 6Y rotated counterclockwise, and then the charging roller 6Y is disposed proximately to or brought into contact with the photoconductor 3Y for uniformly charging the photoconductor 3Y. Notably, instead of the charging roller 6Y, other charging members such as a charging brush may be disposed proximately to or brought into contact with the photoconductor. Also, the photoconductor 3Y may be uniformly charged by a charging method as employed in a scorotron charger. The surface of the photoconductor 3Y uniformly charged by the charging device 5Y is scanned by laser light emitted from the below-described light writing unit 20 serving as a latent image forming unit, to thereby form a latent electrostatic image for Y in the photoconductor surface.

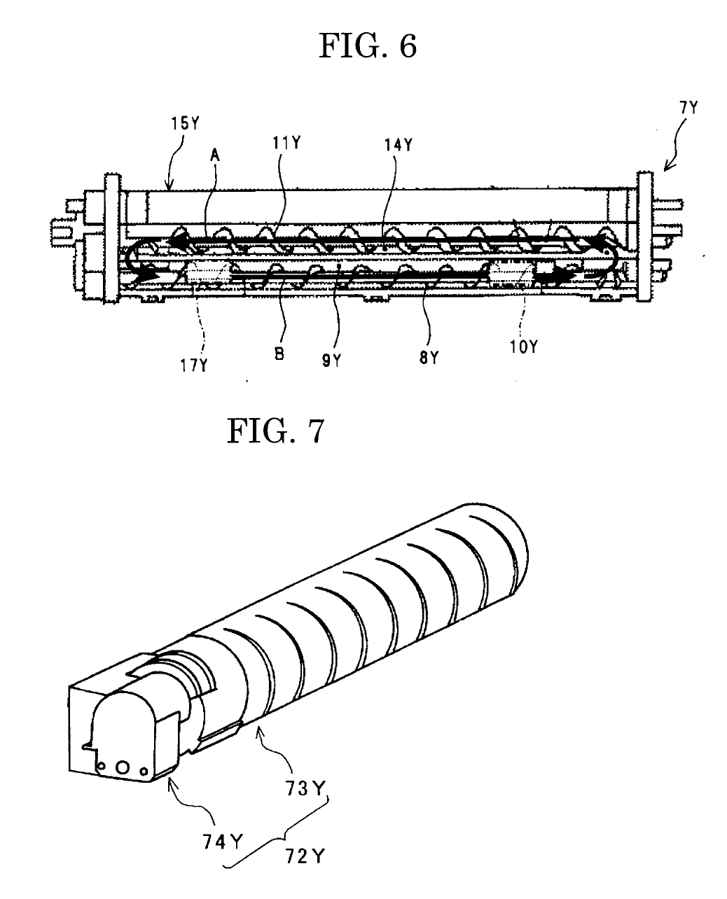

FIG. 6 is an exploded view of the configuration of the interior of the developing unit 7Y. As illustrated in FIGS. 4 and 6, the developing unit 7Y serving as a developing means has a first agent-containing chamber 9Y having therein a first conveying screw 8Y serving as a developer conveying unit. The developing unit 7Y also has a second agent-containing chamber 14Y having therein a toner concentration sensor 10Y (magnetic permeability sensor) serving as a toner concentration-detecting unit, a second conveying screw 11Y serving as a developer conveying unit, a developing roller 12Y serving as a developer bearing member, a doctor blade 13Y serving as a developer regulating member, etc. These two agent-containing chambers form a circulation path and contain a Y developer which is a two-component developer formed of a magnetic carrier and a negatively chargeable Y toner. When rotated by a driving unit, the first conveying screw 8Y conveys the Y developer contained in the first agent-containing chamber 9Y toward the front of FIG. 4 (in the direction indicated by arrow A in FIG. 6). During the course of conveyance, the toner concentration of the Y developer is detected at a predetermined detection position located downstream, in the direction in which the developer is circulated, of a portion facing an agent-supplying port 17Y in the first agent-containing chamber 9Y (hereinafter referred to as “supplying position”). The toner concentration of the Y developer is detected with the toner concentration sensor 10Y fixed above the first conveying screw 8Y. Then, after conveyed by the first conveying screw 8Y to the end of the first agent-containing chamber 9Y, the Y developer enters the second agent-containing chamber 14Y via a communication hole. Notably, in FIG. 4, reference character 18Y denotes a sub-hopper and reference character 19Y denotes a sub-hopper conveying screw.

While rotated by a driving unit, the second conveying screw 11Y in the second agent-containing chamber 14Y conveys the Y developer toward the back of FIG. 4 (in the direction indicated by arrow A in FIG. 6). The developing-roller 12Y is disposed in parallel with the second conveying screw 11Y which conveys the Y developer in the above-described manner. As illustrated in FIG. 4, the developing roller 12Y has a developing sleeve 15Y and a magnet roller 16Y fixed therein, where the developing sleeve 15Y is a non-magnetic sleeve rotated counterclockwise. Part of the Y developer conveyed by the second conveying screw 11Y is attached onto the developing sleeve 15Y by the action of magnetic force derived from the magnet roller 16Y. Thereafter, the thickness of the developer is regulated with the doctor blade 13Y which is disposed so that a predetermined gap is formed between the doctor blade 13Y and the surface of the developing sleeve 15Y. Then, the developer is conveyed to a developing region facing the photoconductor 3Y, and the Y toner is attached to the latent electrostatic image for Y on photoconductor 3Y. Through the attachment, a Y toner image is formed on the photoconductor 3Y. The Y developer whose Y toner has been consumed by the development is returned to the second conveying screw 11Y through the rotation of the developing sleeve 15Y. Then, after conveyed by the second conveying screw 11Y to the end of the second agent-containing chamber 14Y, the Y developer is returned to the first agent-containing chamber 9Y via a communication hole. In this manner, the Y developer is circulated in the developing unit.

In FIG. 3 previously referred to, the Y toner image formed on the photoconductor 3Y is transferred onto an intermediate transfer belt 41 serving as an intermediate transfer medium. The drum-shaped cleaning device 4Y of the photoconductor unit 2Y removes the residual toner on the surface of the photoconductor 3Y having undergone the intermediate transfer step. The surface of the photoconductor 3Y cleaned by the drum-shaped cleaning device 4Y is charge-eliminated with a charge-eliminating device. Through this charge elimination, the surface of the photoconductor 3Y is returned to an initial state ready for the next image formation. Also in the process units 1C, 1M and 1K for the other colors, a C toner image, a M toner image and a K toner image are formed on the photoconductors 3C, 3M and 3K in the same manner as in the Y toner image. These toner images are transferred onto the intermediate transfer belt 41.

The light writing unit 20 is disposed below the process units 1Y, 1C, 1M and 1K. The light writing unit 20 emits laser light L based on image information and applies the laser light L to the photoconductors 3Y, 3C, 3M and 3K of the process units 1Y, 1C, 1M and 1K. Through this application of laser light, latent electrostatic images for Y, C, M and K are formed respectively on the photoconductor 3Y, 3C, 3M and 3K. Notably, in the light writing unit 20, the laser light L emitted from a light source is deflected by a polygon mirror 21 rotated with a motor and then is applied to the photoconductors 3Y, 3C, 3M and 3K via a plurality of optical lenses and mirrors. Alternatively, a light writing unit containing a LED array instead of such configuration may be employed.

Below the light writing unit 20 are disposed a first paper-feeding cassette 31 and a second paper-feeding cassette 32 in a staked manner in the vertical direction. Each of the paper-feeding cassettes contains a plurality of recording paper sheets P (recording materials) stacked. The uppermost recording paper sheet P is in contact with a first paper-feeding roller 31a or a second paper-feeding roller 32a. When the first paper-feeding roller 31a is rotated by a driving unit counterclockwise in FIG. 3, the uppermost recording paper sheet P in the first paper-feeding cassette 31 is discharged toward a paper-feeding path 33 extending in the vertical direction at the right-hand side of the cassette in FIG. 3. Similarly, when the second paper-feeding roller 32a is rotated by a driving unit counterclockwise in FIG. 3, the uppermost recording paper sheet P in the second paper-feeding cassette 32 is discharged toward the paper-feeding path 33. The paper-feeding path 33 is provided with several pairs of conveyance rollers 34. The recording paper sheet P discharged to the paper-feeding path 33 is conveyed from bottom to top in the vertical direction in the paper-feeding path 33 while held between these pairs of conveyance rollers 34. Also, a pair of registration rollers 35 is provided at the end of the paper-feeding path 33. Immediately after the pair of registration rollers 35 hold therebetween the recording paper sheet P fed from the pairs of conveyance rollers 34, both of the registration rollers stop rotating once. Then, the registration rollers feed the recording paper sheet P to the below-described secondary transfer nip at an appropriate timing.

Above the process units 1Y, 1C, 1M and 1K is disposed a transfer unit 40 in which an intermediate transfer belt 41 stretched is moved in an endless manner counterclockwise in FIG. 3. The transfer unit 40 has, in addition to the intermediate transfer belt 41, a belt cleaning unit, a first bracket, a second bracket, etc. The transfer unit 40 also has four primary transfer rollers 45Y, 45C, 45M and 45K, a secondary transfer backup roller 46, a driving roller 47, an assist roller 48, a tension roller 49, etc. While stretched by these rollers, the intermediate transfer belt 41 is moved in an endless manner counterclockwise in FIG. 3 through the rotation of the driving roller 47. The intermediate transfer belt 41 moved in an endless manner is sandwiched between the four primary transfer rollers 45Y, 45C, 45M and 45K and the photoconductors 3Y, 3C, 3M and 3K to form primary transfer nips. In this state, a transfer bias having polarity opposite to that of the toner (positive polarity in this embodiment) is applied to the inner circumferential surface of the intermediate transfer belt 41. While passing sequentially through the primary transfer nips for Y, C, M and K as a result of the movement in an endless manner, the color toner images on the photoconductor 3Y, 3C, 3M and 3K are primarily transferred in a superposed manner onto the outer circumferential surface of the intermediate transfer belt 41. In this manner, a composite toner image of four colors (hereinafter referred to as “four color toner image”) is formed on the intermediate transfer belt 41.

A secondary transfer nip is formed between the secondary transfer backup roller 46 and a secondary transfer roller 50, which sandwich the intermediate transfer belt 41. The secondary transfer roller 50 is disposed outside the loop of the intermediate transfer belt 41. The above-described pair of registration rollers 35 feed the recording paper sheet P held therebetween to the secondary transfer nip in synchronization with the four color toner image on the intermediate transfer belt 41. The four color toner image on the intermediate transfer belt 41 is secondarily transferred at one time onto the recording paper sheet P in the secondary transfer nip due to nip pressure and a secondary transfer electrical field formed between the secondary transfer backup roller 46 and the secondary transfer roller 50 to which a secondary transfer bias is applied. Then, a full color image is formed on the recording paper sheet P of white.

The intermediate transfer belt 41 having passed through the secondary transfer nip has residual toner, which has not been transferred onto the recording paper sheet P. This residual toner is cleaned with a belt cleaning unit. Notably, the belt cleaning unit has a cleaning blade which is brought into contact with the front surface of the intermediate transfer belt 41. The cleaning blade of the belt cleaning unit scrapes off the residual toner on the belt after transfer.

Notably, the first bracket of the transfer unit 40 swings at a predetermined rotation angle with respect to the rotation axis of an assist roller in response to on or off of the driving of a solenoid. In the printer according to this embodiment, when forming a monochromatic image, the first bracket is somewhat rotated counterclockwise in FIG. 3 by driving the solenoid. Through this rotation, the primary transfer rollers 45Y, 45C and 45M for Y, C and M are revolved counterclockwise in FIG. 3 around the rotation axis of the assist roller, to thereby distance the intermediate transfer belt 41 from the photoconductors 3Y, 3C and 3M for Y, C and M. Then, among the four process units 1Y, 1C, 1M and 1K, only the process unit 1K for K is driven to form a monochromatic image. According to this process, the process units for Y, C and M are not driven when forming a monochromatic image, whereby degradation of these process units can be avoided.

In FIG. 3, a fixing unit 60 serving as a fixing means is disposed above the secondary transfer nip. The fixing unit 60 has a fixing belt unit 62 and a pressing heating roller 61 which is contains therein a heat-generating source such as a halogen lamp. The fixing belt unit 62 has, for example, a fixing belt 64, a heating roller 63 containing therein a heat-generating source (e.g., a halogen lamp), a tension roller 65, a driving roller 66 and a temperature-sensor. While supported in a stretched manner by the heating roller 63, the tension roller 65 and the driving roller 66, the endless fixing belt 64 is rotated counterclockwise in FIG. 3 in an endless manner. During the course of the endless movement, the fixing belt 64 is heated by the heating roller 63 from its back surface. The fixing belt 64 heated in this manner is in contact with the pressing heating roller 61 rotated clockwise in FIG. 3 such that the fixing belt 64 is sandwiched between the heating roller 63 and the pressing heating roller 61. As a result, a fixing nip is formed between the pressing heating roller 61 and the fixing belt 64 which are in contact with each other.

The temperature sensor is disposed outside the loop of the fixing belt 64 such that it faces the front surface of the fixing belt 64 via a predetermined gap. The temperature sensor detects the surface temperature of the fixing belt 64 immediately before entering the fixing nip. The obtained detection result is transferred to a fixing power source circuit. On the basis of the detection result obtained with the temperature sensor, the fixing power source circuit controllably turns on or off the current supply to the heat-generating sources contained in the heating roller 63 and the pressing heating roller 61. In this manner, the surface temperature of the fixing belt 64 is maintained at about 140° C. The recording paper sheet P having passed through the secondary transfer nip is separated from the intermediate transfer belt 41 and then is transferred to the fixing unit 60. While the recording paper sheet is being conveyed from bottom to top in FIG. 3 with being held in the fixing nip of the fixing unit 60, the recording paper sheet is heated or pressed with the fixing belt 64, whereby the full color toner image is fixed on the recording paper sheet P.

The recording paper sheet P having undergone such fixing treatment is discharged through a pair of discharge rollers 67 to the outside of the printer. A stack area 68 is provided on a casing of the main body of the printer. After discharged with the pair of discharge rollers 67 to the outside of the printer, the recording paper sheets P are stacked on the stack area 68 one after another.

Above the transfer unit 40 are arranged four agent bottles 72Y, 72C, 72M and 72K which are agent containers housing respectively premix agents for Y, C, M and K. The premix agents in the agent bottles 72Y, 72C, 72M and 72K are appropriately supplied by an agent supplying device to the developing units 7Y, 7C, 7M and 7K of the process units 1Y, 1C, 1M and 1K. The agent bottles 72Y, 72C, 72M and 72K are detachably mountable to the main body of the printer independently of the process units 1Y, 1C, 1M and 1K.

As shown in FIG. 6 previously referred to, the toner concentration sensor 10Y detects the toner concentration of the developer immediately before transferring from the first agent-containing chamber 9Y (serving as a non-supplying region) to the second agent-containing chamber 14Y (serving as a supplying region). The agent-supplying port 17Y is provided at a position where the premix agent is supplied to the developer immediately after entering the first agent-containing chamber 9Y from the second agent-containing chamber 14Y. That is, in the first agent-containing chamber 9Y, the toner concentration sensor 10Y detects the toner concentration of the developer at a position downstream of the agent-supplying port 17Y.

This printer employs a Mohno pump (aspiration pump) as a means of providing agent conveyance power for conveying (supplying) the premix agents in the agent bottles 72Y, 72C, 72M and 72K (see FIG. 3) to the agent-supplying ports of the corresponding developing units. The Mohno pump is a pump excellent in quantitative performance (supply resolution) and realizes agent supply well correlated with the rotation speed thereof. Before shipped from factories, the agent bottles 72Y, 72C, 72M and 72K according to the embodiment contains the Y, C, M and K premix agents according to the embodiment containing the toner and the carrier previously mixed together.

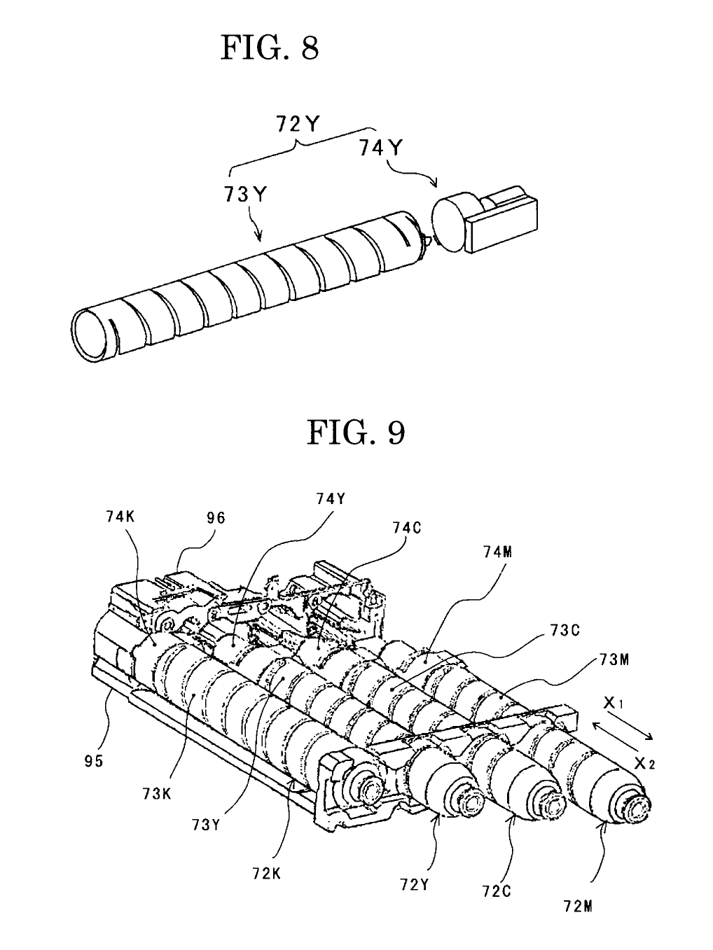

FIG. 7 is a perspective view of the agent bottle 72Y for Y according to the embodiment. In this figure, the agent bottle 72Y for Y has a bottle 73Y and a cylindrical holder 74Y, where the bottle 73Y serves as a powder container for the Y premix agent and the cylindrical holder 74Y serves as a powder discharging member. As shown in FIG. 8, the holder 74Y is engaged with the head portion of the bottle 73Y to hold the bottle 73Y freely rotatably. The inner circumferential surface of the bottle 73Y is provided with a screw-shaped helical convex portion (which is protruded from outside to inside of the container) which extends along the longitudinal axis of the bottle.

FIG. 9 is a perspective view of an agent supplying device of this printer. In this figure, the agent supplying device serving as an agent supplying unit has, for example, a bottle rest 95 for the four agent bottles 72K, Y, C and M and a bottle driving portion 96 which rotates the bottles individually. In the agent bottles 72K, Y, C and M set on the bottle rest 95, their holders are engaged with the bottle driving portion 96. As indicated by the arrow X1 in FIG. 9, when the agent bottle 72M engaged with the bottle driving portion 96 is slid on the bottle rest 95 in the direction distancing from the bottle driving portion 96, the holder 74M of the agent bottle 72M is separated from the bottle driving portion 96. In this manner, the agent bottle 72M can be separated from the agent supplying device. Also, in the agent supplying device to which the agent bottle 72M is not mounted, when the agent bottle 72M is slid on the bottle rest 95 toward the bottle driving portion 96 in the direction indicated by the arrow X2 in this figure, the holder 74M of the agent bottle 72M is engaged with the bottle driving portion 96. In this manner, the agent bottle 72M can be mounted to the agent supplying device. In the same manner, the other agent bottles 72K, Y and C can be separated from and mounted to the agent supplying device.

A gear is formed on the outer circumferential surface of the head of each of the bottles 73K, Y, C and M of the agent bottles 72Y, C, M and K. This gear is covered with each of the holders 74K, Y, C and M. Part of the circumferential surface of each of the holders 74K, Y, C and M is provided with a notch from which the gear is partially exposed. Part of the gear is exposed from the notch. When the holders 74K, Y, C and M of the agent bottles 72K, Y, C and M are engaged with the bottle driving portion 96, bottle driving gears for K, Y, C and M provided in the bottle driving portion 96 are engaged with the gears of the bottles 73K, Y, C and M via the notches. Then, the bottle driving gears for K, Y, C and M of the bottle driving portion 96 are rotated by a driving system, the bottles 73K, Y, C and M are rotated on the holders 74K, Y, C and M.

In FIG. 7 previously referred to, when the bottle 73Y is rotated on the holder 74Y, the Y premix agent is moved from the bottle bottom to the bottle head of the bottle 73Y along the above-described screw-shaped herical convex portion. The Y premix agent is, then, transferred into the cylindrical holder 74Y via a bottle opening which is provided at the tip of the bottle 73Y serving as a powder container.

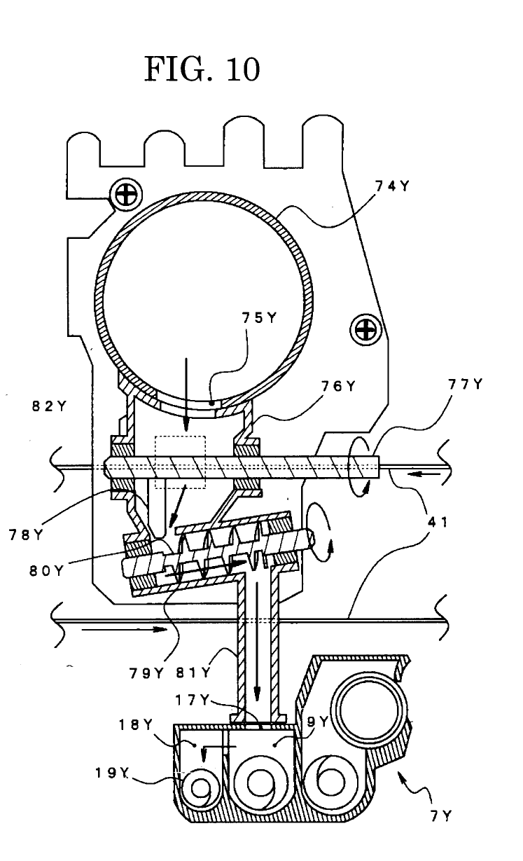

FIG. 10 is a schematic view of the toner bottle mounted to the agent supplying device as well as the configuration surrounding the toner bottle. The agent bottle in this figure is illustrated with its cross section taken along the holder 74Y. As described above, this holder 74Y receives the Y premix agent conveyed in the bottle in response to the rotation of the bottle present at the back side of the holder 74Y in this figure. The holder 74Y of the agent bottle is engaged with a hopper 76Y of the agent supplying device. This hopper 76Y has a flat shape extending in the perpendicular direction to the figure and, in this figure, is located at the front side of the intermediate transfer belt 41. The agent discharge port 75Y formed at the bottom of the holder 74Y is in communication with an agent receiving port formed in the hopper 76Y of the agent supplying device. After fed to the holder 74Y from the bottle of the agent bottle, the Y premix agent falls into the hopper 76Y by its own weight. In the hopper, a rotatable rotation shaft 77Y is rotated together with a highly flexible press film 78Y which is fixed on the rotatable rotation shaft 77Y. An agent detection sensor 82Y formed of piezoelectric element is fixed on the inner wall of the hopper 76Y. The agent detection sensor 82Y detects the presence or absence of the premix agent in the hopper. While rotated, the press film 78Y (e.g., a PET (polyethylene terephthalate) film) presses the Y premix agent against the detection surface of the agent detection sensor 82Y. As a result, it is possible for the agent detection sensor 82 to accurately detect the Y premix agent in the hopper 76Y. The rotation of the bottle of the agent bottle is controlled so that the agent detection sensor 82Y accurately detects the Y premix agent. Thus, so long as there is a sufficient amount of the Y premix agent in the bottle, a sufficient amount of the Y premix agent falls from the bottle into the hopper 76Y via the holder 74Y, whereby the hopper 76Y is filled with a sufficient amount of the Y premix agent. When the agent detection sensor 82Y is difficult to detect the premix agent although the bottle is frequently rotated, a control portion reports the notice “agent nearly ends” to the users by judging that there is a slight amount of the Y premix agent left in the bottle.

A laterally conveying pipe 79Y is connected with a lower portion of the hopper 76Y. The Y premix agent in the hopper 76Y slides on the taper by its own weight to fall into the laterally conveying pipe 79Y. The laterally conveying pipe 79Y is provided therein with an agent supply screw 80Y. In response to the rotation of the agent supply screw 80Y, the Y premix agent is laterally conveyed along the longitudinal direction in the laterally conveying pipe 79Y.

A fall guide pipe 81Y is connected with a part of the laterally conveying pipe 79Y in the longitudinal direction such that the fall guide pipe 81Y extends in the vertical direction. The lower end of the fall guide pipe 81Y is connected with the agent supply port 17Y of the first agent-containing chamber 9Y of the developing unit 7Y. When the agent supply screw 80Y in the laterally conveying pipe 79Y is rotated, the Y premix agent conveyed to the end of the laterally conveying pipe 79Y in the longitudinal direction falls into the first agent-containing chamber 9Y of the developing unit 7Y through the fall guide pipe 81Y and the agent supply port 17Y. In this manner, the Y premix agent is supplied to the first agent-containing chamber 9Y. The other premix agents (C, M and K) are supplied in the same manner.

The toner according to the embodiment described above preferably contains, as a release promoter, a microcrystalline wax which contains C20-C80 hydrocarbons containing a linear hydrocarbon in an amount of 55% by mass to 70% by mass and has an endothermic peak temperature of 65° C. to 90° C. measured through differential scanning calorimetry. The release promoter having the above properties can avoid acceleration of carrier degradation due to exudation of an excessive amount of the microcrystalline wax onto the toner surface and also avoid degradation of toner releaseability due to localization of the microcrystalline wax in the toner.

Also, in the toner according to the embodiment, the amount of the release promoter contained in each of the base particles is preferably adjusted to be 1% to 20%. This adjustment can avoid acceleration of carrier degradation due to contamination of the carrier with the microcrystalline wax while suppressing generation of offset of the toner during fixing.

Further, the toner according to the embodiment, the endothermic peak temperature of the crystalline polyester resin is preferably adjusted to 50° C. to 150° C. measured through differential scanning calorimetry. This adjustment can avoid acceleration of carrier degradation due to contamination of the carrier with crystalline polyester resin, avoid degradation of image quality due to aggregation of the toner during storage, and avoid failures due to localization of the crystalline polyester resin in the toner.

### EXAMPLES

Next will be described the experiments conduced by the present inventor.

First, the present inventor prepared toner materials as follows to obtain toners having various properties.

### Example 1

### <Synthesis of Emulsion of Fine Organic Particles>

A reaction container to which a stirring rod and a thermometer had been set was charged with 700 parts by mass of water, 12 parts by mass of a sodium salt of sulfate of an ethylene oxide adduct of methacrylic acid (Eleminol RS-30, product of Sanyo Chemical Industries, Ltd.), 140 parts by mass of styrene, 140 parts by mass of methacrylic acid and 1.5 parts by mass of ammonium persulfate. The resultant mixture was stirred at 450 rpm for 20 min. The system of the obtained white emulsion was increased in temperature to 75° C., followed by reaction for 5 hours. Then, 35 parts by mass of a 1% aqueous ammonium persulfate solution was added to the resultant emulsion, and the resultant mixture was aged at 75° C. for 5 hours, to thereby obtain an aqueous dispersion liquid of a vinyl resin (copolymer of styrene-methacrylic acid-sodium salt of sulfate of an ethylene oxide adduct of methacrylic acid) [fine particle dispersion liquid 1]. Through measurement with LA-920 (described below in detail), the [fine particle dispersion liquid 1] was found to have a volume average particle diameter of 0.30 μm. Part of the [fine particle dispersion liquid 1] was dried to isolate resin. This resin was found to have a Tg of 155° C.

### <Preparation of Aqueous Phase>

Water (1,000 parts by mass), 85 parts by mass of the [fine particle dispersion liquid 1]), 40 parts by mass of a 50% aqueous solution of sodium dodecyldiphenylethersulfonate (Eleminol MON-7, product of Sanyo Chemical Industries, Ltd.) and 95 parts by mass of ethyl acetate were mixed together to prepare a milky white liquid, which was used as [aqueous phase 1].

### <Synthesis of Low-Molecular-Weight Polyester <Hydroxyl Group-Containing Polyester>>

A reaction container equipped with a condenser, a stirrer and a nitrogen-introducing tube was charged with 235 parts by mass of bisphenol A ethylene oxide 2 mol adduct, 535 parts by mass of bisphenol A propylene oxide 3 mol adduct, 215 parts by mass of terephthalic acid, 50 parts by mass of adipic acid and 3 parts by mass of dibutyltinoxide. The resultant mixture was allowed to react at 240° C. for 10 hours under normal pressure and then at a reduced pressure of 10 mmHg to 20 mmHg for 6 hours. Thereafter, 45 parts by mass of trimellitic anhydride was added to the reaction container, followed by reaction at 185° C. for 3 hours under normal pressure, to thereby produce [low-molecular-weight polyester 1]. The [low-molecular-weight polyester 1] was found to have a number average molecular weight of 2,800, a weight average molecular weight of 7,100, a Tg of 45° C. and an acid value of 22 mgKOH/g.

### <Synthesis of Polyester Prepolymer <Isocyanate Group-Containing Polyester Prepolymer>>

A reaction container equipped with a condenser, a stirrer and a nitrogen-introducing tube was charged with 700 parts by mass of bisphenol A ethylene oxide 2 mol adduct, 85 parts by mass of bisphenol A propylene oxide 2 mol adduct, 300 parts by mass of terephthalic acid, 25 parts by mass of trimellitic anhydride and 3 parts by mass of dibutyitinoxide. The resultant mixture was allowed to react at 240° C. for 10 hours under normal pressure and then at a reduced pressure of 10 mmHg to 20 mmHg for 6 hours, to thereby obtain [intermediate polyester 1]. The [intermediate polyester 1] was found to have a number average molecular weight of 2,500, a weight average molecular weight of 10,000, a Tg of 58° C., an acid value of 0.5 mgKOH/g and a hydroxyl value of 52 mgKOH/g.

Next, a reaction container equipped with a condenser, a stirrer and a nitrogen-introducing tube was charged with 400 parts by mass of the [intermediate polyester 1], 90 parts by mass of isophoron diisocyanate and 500 parts by mass of ethyl acetate. The resultant mixture was allowed to react at 110° C. for 6 hours to obtain [prepolymer 1]. The amount of the free isocyanate contained in the [prepolymer 1] was found to be 1.67% by mass.

### <Synthesis of Crystalline Polyester 1>

A 5-L four-necked flask equipped with a nitrogen-introducing tube, a dehydrating tube, a stirrer and a thermocouple was charged with 1,4-butanediol (28 mol), fumaric acid (24 mol), trimellitic anhydride (1.80 mol) and hydroquinone (6.0 g), followed by reaction at 160° C. for 6 hours. The reaction mixture was allowed to react at 200° C. for 1 hour, and further react at 8.3 kPa for 1 hour, to thereby obtain [crystalline polyester 1]. The [crystalline polyester 1] was found to have a melting point of 150° C. (endothermic peak temperature in DSC), a Mn of 800 and a Mw of 3,000.

### <Synthesis of Ketimine>

A reaction container to which a stirring rod and a thermometer had been set was charged with 180 parts by mass of isophorondiamine and 80 parts by mass of methyl ethyl ketone, followed by reaction at 50° C. for 6 hours, to thereby obtain [ketimine compound 1]. The [ketimine compound 1] was found to have an amine value of 420 mgKOH/g.

### <Synthesis of Masterbatch <MB>>

Water (1,300 parts by mass), 550 parts of carbon black (Printex35, product of Deggusa Co.) (DBP oil-absorption amount=43 mL/100 mg, pH=9.5) and 1,300 parts by mass of [low-molecular-weight polyester 1] were mixed together using HENSCHEL MIXER (product of Mitsui Mining Co.). Using a two-roll mill, the resultant mixture was kneaded at 160° C. for 45 min, followed by calendering, cooling and pulverizing with a pulverizer, to thereby obtain [masterbatch 1].

### <Preparation of Oil Phase <Pigment-WAX Dispersion Liquid 1>>

A container to which a stirring rod and a thermometer had been set was charged with 400 parts by mass of the [low-molecular-weight polyester 1], 100 parts by mass of microcrystalline wax (acid value: 0.1 mgKOH/g, melting point: 65° C., number of carbon atoms: 20, amount of linear hydrocarbon: 70% by mass), 20 parts by mass of CCA (salicylic acid metal complex E-84 (product of Orient Chemical Industries, Ltd.) and 1,000 parts by mass of ethyl acetate. Then, the resultant mixture was increased in temperature to 80° C. under stirring, maintained at 80° C. for 8 hours, and cooled to 24° C. for 1 hour. Next, the [masterbatch 1] (480 parts by mass) and ethyl acetate (550 parts by mass) were added to the container, followed by mixing for 1 hour, to thereby obtain [raw material solution 1]. The [raw material solution 1] was placed in another container, where the carbon black and the WAX were dispersed using a bead mill (Ultra Visco Mill, product of Aymex Co.) under the following conditions: liquid-feeding rate: 1 kg/hour; disc circumferential speed: 6 m/sec; amount of 0.5 mm (diameter)-zirconia beads charged: 80% by volume; and pass time: 3. Next, 1,000 parts of 65% ethyl acetate solution of the [low-molecular-weight polyester 1] was added thereto and passed with the bead mill once under the above conditions, to thereby obtain [pigment-WAX dispersion liquid 1]. The concentration of the solid content of the [pigment-WAX dispersion liquid 1] was found to be 53% by mass (measurement conditions: 130° C., 30 min).

### <Preparation of Crystalline Polyester Resin Dispersion Liquid>

The [crystalline polyester resin 1] (110 g) and ethyl acetate (450 g) were added to a 2 L metal container. The resultant mixture was dissolved or dispersed at 80° C. under heating and then quenched in an ice-water bath. Subsequently, glass beads (3 mm in diameter) (500 mL) were added to the mixture, followed by stirring for 10 hours with a batch-type sand mill (product of Kanpe Hapio Co., Ltd.), to thereby obtain [crystalline polyester resin dispersion liquid 1] having a volume average particle diameter of 0.4 μm.

Next, these materials were used to produce toners.

### Toner A

First, the following emulsification step was performed. Specifically, a container was charged with 700 parts by mass of [pigment-WAX dispersion liquid 1], 120 parts by mass of [prepolymer 1], 80 parts by mass of [crystalline polyester dispersion liquid 1] and 5 parts by mass of [ketimine compound 1]. The resultant mixture was mixed with TK homomixer (product of PRIMIX Corporation) at 6,000 rpm for 1 min. The [aqueous phase 1] (1,300 parts) was added to the container, followed by mixing using the TK homomixer at 13,000 rpm for 20 min, to thereby obtain [emulsified slurry 1].

Next, the following desolvating step was performed. Specifically, the [emulsified slurry 1] was added to a container to which a stirrer and a thermometer had been set, followed by desolvating at 30° C. for 10 hours and aging at 45° C. for 5 hours, to thereby obtain [dispersion slurry 1].

The [emulsified slurry 1] (100 parts by mass) was filtrated under reduced pressure and then subjected twice to a series of treatments (1) to (4) described below, to thereby obtain [filtration cake 1]:

(1): ion-exchanged water (100 parts by mass) was added to the filtration cake, followed by mixing with a TK homomixer at 12,000 rpm and then filtration;

(2); 10% aqueous sodium hydroxide solution (100 parts by mass) was added to the filtration cake obtained in (1), followed by mixing with a TK homomixer at 12,000 rpm and then filtration under reduced pressure;

(3): 10% hydrochloric acid (100 parts by mass) was added to the filtration cake obtained in (2), followed by mixing with a TK homomixer at 12,000 rpm for 10 min and then filtration; and

(4): ion-exchanged water (300 parts by mass) was added to the filtration cake obtained in (3), followed by mixing with a TK homomixer at 12,000 rpm for 10 min and then filtration.

The [filtration cake 1] was dried with an air-circulating drier at 45° C. for 48 hours, and then was caused to pass through a sieve with a mesh size of 75 μm, to thereby prepare [base particles 1].

The thus-obtained [base particles 1] (100 parts by mass) were mixed with 0.7 parts by mass of hydrophobic silica and 0.3 parts by mass of hydrophobic titanium oxide using HENSCHEL MIXER, to thereby produce toner A containing the base particles.

The volume average particle diameter (Dv) of the toner A was found to be 6.0 μm. Also, the ratio (Dv/Dn) of the volume average particle diameter thereof to the number average particle diameter thereof was found to be 1.25.

### Example 2

### Toner B

The procedure of the production for toner A was repeated, except that the amount of the [crystalline polyester dispersion liquid 1] was changed from 80 parts by mass to 5 parts by mass, to thereby produce toner B.

The volume average particle diameter (Dv) of the toner B was found to be 3.0 μm. Also, the ratio (Dv/Dn) of the volume average particle diameter thereof to the number average particle diameter thereof was found to be 1.05.

### Comparative Example 1

### Toner C

The procedure of the production for toner A was repeated, except that the amount of the [crystalline polyester dispersion liquid 11 was changed from 80 parts by mass to 4 parts by mass, to thereby produce toner C.

The volume average particle diameter (Dv) of the toner C was found to be 6.0 μm. Also, the ratio (Dv/Dn) of the volume average particle diameter thereof to the number average particle diameter thereof was found to be 1.25.

### Example 3

### Toner D

The procedure of the production for toner A was repeated, except that the [pigment-WAX dispersion liquid 11 (700 parts by mass) was changed to the below-prepared [pigment-WAX dispersion liquid 21 (700 parts by mass), to thereby produce toner D.

The volume average particle diameter (Dv) of the toner D was found to be 6.0 μm. Also, the ratio (Dv/Dn) of the volume average particle diameter thereof to the number average particle diameter thereof was found to be 1.25.

### <Preparation of Oil Phase <Pigment-WAX Dispersion Liquid 2>>

The procedure of the production for the [pigment-WAX dispersion liquid 1] was repeated, except that the microcrystalline wax was changed to microcrystalline wax having an acid value of 0.1 mgKOH/g, a melting point of 90° C., 80 carbon atoms and a liner hydrocarbon in an amount of 55% by mass, to thereby obtain [pigment-WAX dispersion liquid 2].

### Example 4

### Toner E

The procedure of the production for toner A was repeated, except that the amount of the [pigment-WAX dispersion liquid 1] was changed from 700 parts by mass to 50 parts by mass, to thereby produce toner E.

The volume average particle diameter (Dv) of the toner E was found to be 6.0 μm. Also, the ratio (Dv/Dn) of the volume average particle diameter thereof to the number average particle diameter thereof was found to be 1.25.

### Example 5

### Toner F

The procedure of the production for toner A was repeated, except that the [crystalline polyester dispersion liquid 1] (80 parts by mass) was changed to the below-prepared [crystalline polyester dispersion liquid 2] (80 parts by mass), to thereby produce toner F.

The volume average particle diameter (Dv) of the toner F was found to be 6.0 μm. Also, the ratio (Dv/Dn) of the volume average particle diameter thereof to the number average particle diameter thereof was found to be 1.25.

### <Synthesis of Crystalline Polyester 2>

A 5-L four-necked flask equipped with a nitrogen-introducing tube, a dehydrating tube, a stirrer and a thermocouple was charged with 1,4-butanediol (28 mol), fumaric acid (24 mol), trimellitic anhydride (1.80 mol) and hydroquinone (6.0 g), followed by reaction at 120° C. for 3 hours. The reaction mixture was allowed to react at 180° C. for 0.5 hours, and further react at 8.3 kPa for 0.5 hours, to thereby obtain [crystalline polyester 2]. The [crystalline polyester 2] was found to have a melting point of 50° C. (endothermic peak temperature in DSC), a Mn of 500 and a Mw of 1,000.

### <Preparation of Crystalline Polyester Dispersion Liquid>

The procedure of the preparation for the crystalline polyester dispersion liquid 1 was repeated, except that the crystalline polyester 1 was changed to the crystalline polyester 2, to thereby prepare crystalline polyester dispersion liquid 2.

### Comparative Example 2

### Toner G

The procedure of the production for toner A was repeated, except that [pigment-WAX dispersion liquid 1] (700 parts by mass) was changed to the below-prepared [pigment-WAX dispersion liquid 3] (700 parts by mass), to thereby prepare toner G.

The volume average particle diameter (Dv) of the toner G was found to be 6.0 μm. Also, the ratio (Dv/Dn) of the volume average particle diameter thereof to the number average particle diameter thereof was found to be 1.25.

### <Preparation of Oil Phase <Pigment-WAX Dispersion Liquid 3>>

The procedure of the production for the [pigment-WAX dispersion liquid 1] was repeated, except that the microcrystalline wax was changed to microcrystalline wax having 85 carbon atoms and a liner hydrocarbon in an amount of 50% by mass, to thereby obtain [pigment-WAX dispersion liquid 3].

The present inventor measured toners A to G in terms of the number of carbon atoms of the release promoter (microcrystalline wax), the amount of the linear hydrocarbon (% by mass), the melting point, and the endothermic peak temperature of the non-crystalline polyester resin (one binder resin).

The number of carbon atoms or the average number of carbon atoms contained in the release promoter was measured through, for example, high-temperature gel permeation chromatography (high-temperature GPC). In the chromatogram of the release promoter measured through high-temperature GPC, the number of carbon atoms contained in the release promoter refers to a value obtained through dividing the molecular weight of the release promoter when the elution initiates by the molecular weight of the methylene group; i.e., 14 and a value through dividing the molecular weight of the release promoter when the elution terminates by the molecular weight of the methylene group; i.e., 14. That is, the obtained values show the distribution of carbon atoms constituting the hydrocarbon. Also, the average number of carbon atoms refers to a value through dividing the peak molecular weight by the molecular weight of the methylene group; i.e., 14, in the chromatogram of the release promoter measured through high-temperature GPC.

The amount of the linear hydrocarbon contained in the release promoter was measured through gas chromatography. A linear hydrocarbon and a non-linear hydrocarbon in the form of mixture are separated from each other when being moved over a stationary phase by carrier gas, since they are moved at different rates due to their different adsorption or distribution profiles onto the stationary phase. Thus, the amount of the linear hydrocarbon contained is calculated from the retention time of peaks appearing in the gas chromatogram and the peak area ratio. The separation column used in the gas chromatography is a packed column and a capillary column. The filler used in the packed column may be activated carbon, activated alumina, silica gel, porous spherical silica, molecular sieves, other adsorptive materials (e.g., inorganic salts); diatomaceous earth, refractory brick powder, glass, fused silica beads, and fine particles (e.g., graphite particles) each having on the surface a thin film of paraffin oil, silicone oil, etc. When the separation column used is a capillary column, paraffin oil silicone oil, etc. may be applied before use without using any filler. The carrier gas may be nitrogen, helium, hydrogen and argon. The detector used for the gas chromatography may be a thermal conductivity meter of heat ray, a gas densitometer, an ionization cross section meter, and ionization detectors (e.g., hydrogen flame, β rays, electron trapping and radio-frequency waves). The release promoter is separated/purified from the residual oil after reduced-pressure distillation or heavy distillate of oil, followed by fractionating through high-temperature GPC.

Notably, in the Examples, the amount of the linear hydrocarbon contained in the release promoter was measured under the following conditions.

Specifically, 2.55 mg of DMF was used as an internal standard and mixed with 100 mL of acetone to prepare a solvent containing the internal standard. Next, 400 mg of the release promoter was diluted with the above-obtained solvent to prepare 10 mL of a solution. The resultant solution was treated with an ultrasonic shaker for 30 min and then left to stand for 1 hour. Next, the resultant mixture was filtrated with a 0.5-μm filter. The amount of the sample applied to a gas chromatography measurement apparatus was 4 μL.

The conditions for gas chromatography are as follows.
Capillary column (30 m×0.249 mm, DBWAX, film thickness: 0.25 μm)
Detector FID, nitrogen pressure: 0.45 kg/cm²
Injection temperature: 200° C.
Detector temperature: 200° C.
Column temperature: increased from 50° C. at a temperature increasing rate of 5° C./min for 30 min

The melting point of the release promoter is the endothermic peak temperature; i.e., the temperature at which the amount of heat absorbed becomes maximum in the differential scanning calorimetry curve obtained through differential scanning calorimetry (DSC). The endothermic peak temperature of the crystalline polyester resin was also measured through differential scanning calorimetry.

Next, the present inventor analyzed toners A to G for infrared absorption spectra of the crystalline polyester resin and non-crystalline polyester resin of the binder resin. The infrared spectroscopic analysis was conducted by the KBr method (a total transmission method) using FT-IR (a Fourier transform infrared spectrometer AVATAR370 (product of ThermoElectron Corporation)). The infrared absorption spectrum is a graph of two-dimensional coordination in which the horizontal axis corresponds to Wavenumbers of infrared ray applied and the vertical axis corresponds to Absorbance. From this graph, the structure of an analyte can be determined.

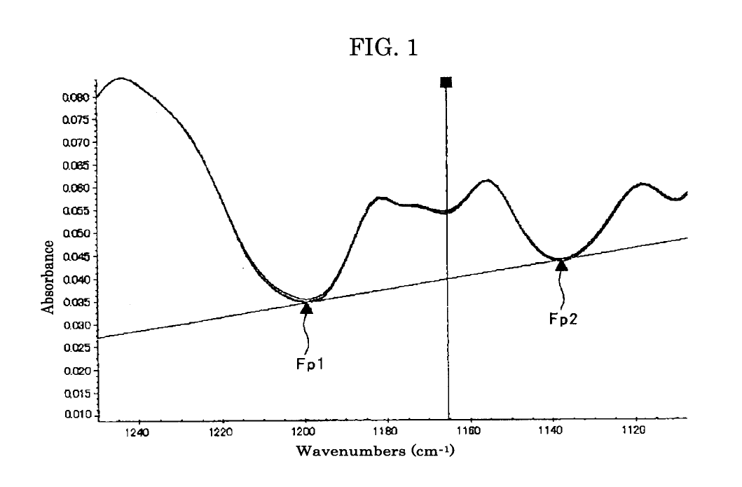

FIG. 1 is an exemplary infrared absorption spectrum of a crystalline polyester resin. As shown in FIG. 1, the infrared absorption spectrum of the crystalline polyester resin is characterized in that there is one bottom peak between the peak of the lowest absorbance (hereinafter referred to as “first bottom peak Fp1) and the peak of the second lowest absorbance (hereinafter referred to as “second bottom peak Fp2”). In this specification, the bottom peak between the first and second peaks is defined as third bottom peak Fp3. The line segment connecting the first bottom peak Fp1 with the second bottom peak Fp2 is used as a baseline. Then, the height W of the third bottom peak Fp3 is defined as an absolute value of the difference between the absorbance at the third bottom peak Fp3 and an intersection point which is formed by the baseline and the vertical line drawn from the third bottom peak Fp3 to the horizontal axis.

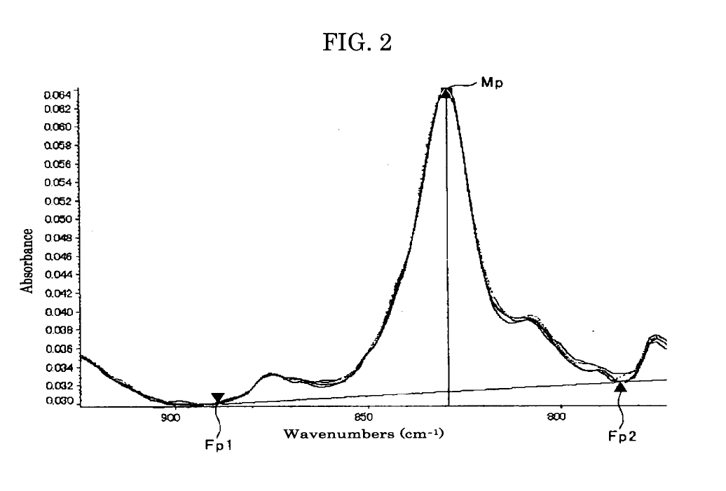

FIG. 2 is an exemplary infrared absorption spectrum of a non-crystalline polyester resin. As shown in FIG. 2, the infrared absorption spectrum of the non-crystalline polyester resin is characterized in that the maximum top peak Mp of the highest absorbance is much higher than the other top peaks. The line segment connecting the first top peak Fp1 with the second top peak Fp2 is used as a baseline. Then, the height R of the maximum top peak Mp is defined as an absolute value of the difference between the absorbance at the maximum top peak Mp and an intersection point which is formed by the baseline and the vertical line drawn from the maximum top peak Mp to the horizontal axis.

Also, the ratio W/R is defined as a peak ratio. The above-produced toners A to G were measured for peak ratio W/R.

Next, the present inventor produced premix agent toners A, B, C, D, E, F and G by mixing each of toners A, B, C, D, E, F and G with copper-zinc ferrite carriers. The mixing ratio therebetween was set to 10% by mass (toner) 90% by mass (copper-zinc ferrite carrier). The mixing was performed by mixing/stirring the mixture with TURBULA shaker mixer (product of SHINMARU ENTERPRISES CORPORATION) at 71 rpm for 5 min. The copper-zinc ferrite carrier used was a copper-zinc ferrite carrier coated with a silicone resin and having an average particle diameter of 40 μm.

Each premix agent was used to perform a printing test. The printer used in the printing test was RICOH Pro c900s (product of Ricoh Company Ltd.). In the printing test of the premix agent, a test image having a coverage rate of 6% was continuously printed out on 50,000 sheets of A3 paper. Thereafter, a sample image of 1 dot line was output on three sheets of A3 paper. The obtained sheets were visually evaluated for thin-line reproducibility of 1 dot line. Specifically, the evaluation was performed based on an organoleptic evaluation by visually comparing the sample image with a previously printed 1 dot line image sample for judging a rank. The following criteria were employed: A: Very good, B: Good, C: Somewhat bad, D: Bad.

After the test image having a coverage rate of 6% had been continuously printed out on 50,000 sheets of A3 paper using each premix agent, blank images were developed and the print job was suspended during the development. Then, the toner was peeled off with a piece of an adhesive tape from the photoconductor having passed through the developing region. Thereafter, 938 spectrodensitometer (product of X-Rite Inc.) was used to measure the difference in image density (ΔID) between the adhesive tape and an adhesive tape having no toner transferred. The difference in image density therebetween (ΔID) was evaluated according to the following evaluation criteria: A: 0≦ΔID≦0.40, B: 0.41≦ΔID≦0.70, C: 0.71≦ΔID≦1.00 and D: 1.01≦ΔID. Poorly charged toner particles are easily transferred onto the background region of the photoconductor. Thus, the more the poorly charged toner particles, the higher the difference in image density therebeween (ΔID).

The results of the experiment are shown in the following Table 1.

TABLE 1

| | | | | | | | | Evaluation of |
|---|---|---|---|---|---|---|---|---|
| | | | | | | Endothermic | | background |
| | | | Amount | Amount of | | temperature of | | smear based on |
| | Peak | | of linear | release promoter | Melting point of | crystalline | Evaluation of | the difference |
| | ratio | Number of | hydrocarbon | in base particles | release promoter | polyester resin | thin-line | in image |
| | W/R | carbon atoms | (% by mass) | (% by mass) | (° C.) | (° C.) | reproducibility | density (ΔID) |
| Toner A | 0.850 | 20 | 70 | 20 | 65 | 150 | A | B |
| Toner B | 0.045 | 20 | 70 | 20 | 65 | 150 | B | B |
| Toner C | 0.042 | 20 | 70 | 20 | 65 | 150 | D | B |
| Toner D | 0.840 | 80 | 55 | 20 | 90 | 150 | B | B |
| Toner E | 0.849 | 20 | 70 | 1 | 65 | 150 | B | A |
| Toner F | 0.845 | 20 | 70 | 20 | 65 | 50 | A | C |
| Toner G | 0.860 | 85 | 50 | 20 | 65 | 150 | D | C |

As shown in Table 1, the toner C was a toner the peak ratio W/R of which was the lowest among the seven toners (W/R=0.042). The toner C could not reproduce the thin line satisfactorily (rank D). The toner B had the second lowest peak ratio W/R after the toner C (W/R=0.045) but could reproduce the thin line satisfactorily (rank B). The difference in image density (AID) in the toner B was small (rank B). Thus, to suppress degradation in image quality due to unevenness of the charge amount of the toner, it is necessary to use a toner having a peak ratio W/R of 0.045 or higher.

This application claims priority to Japanese patent application No. 2010-200463, filed on Sep. 8, 2010, and incorporated herein by reference.

What is claimed is:

1. A toner comprising:
a binder resin, and
a release promoter,
wherein the binder resin contains at least a crystalline polyester resin and a non-crystalline polyester resin,
wherein a value of W/R is in a range of 0.045 to 0.850 where W denotes a height of a third bottom peak in an infrared absorption spectrum of the crystalline polyester resin and R denotes a height of a maximum top peak in an infrared absorption spectrum of the non-crystalline polyester resin and each of the infrared absorption spectra is measured by an infrared spectroscopic method (KBr method) using a Fourier transform infrared spectrometer,
wherein the toner is used as a toner contained together with a carrier in a premix agent which is a developer containing the toner and the carrier previously mixed together before shipment, and
wherein the premix agent is used in an image forming apparatus which comprises:
a latent image bearing member,
a developing device for developing a latent image on the latent image bearing member with the developer containing the toner and the carrier, and
an agent supplying unit configured to supply the premix agent to the developing device.

2. The toner according to claim 1, wherein the toner contains base particles, and each of the base particles contains, as the release promoter, a microcrystalline wax which is formed of a C20-C80 hydrocarbon containing a linear hydrocarbon in an amount of 55% by mass to 70% by mass and has an endothermic peak temperature of 65° C. to 90° C. measured through differential scanning calorimetry.

3. The toner according to claim 2, wherein an amount of the release promoter contained in the base particles is 1% by mass to 20% by mass.

4. The toner according to claim 1, wherein the crystalline polyester resin has an endothermic peak temperature of 50° C. to 150° C. measured through differential scanning calorimetry.

5. The toner according to claim 1, wherein the toner has a volume average particle diameter of 3.0 μm to 6.0 μm.

6. The toner according to claim 1, wherein a ratio of a volume average particle diameter of the toner to a number average particle diameter of the toner is 1.05 to 1.25.

7. The toner according to claim 1, wherein the toner is obtainable by a method comprising:
adding to an organic solvent at least the binder resin and a precursor of the binder resin, or at least the binder resin, a precursor of the binder resin, and the release promoter, to thereby prepare a liquid,
adding the liquid to an aqueous medium to prepare an emulsion or dispersion liquid, and
removing the organic solvent from the emulsion or dispersion liquid to form the base particles.

8. A premix agent comprising:
the toner according to claim 1, and
a carrier,
wherein the premix agent is a developer containing the toner and the carrier previously mixed together before shipment and is used in an image forming apparatus which comprises:
a latent image bearing member,
a developing device for developing a latent image on the latent image bearing member with the developer containing the toner and the carrier, and
an agent supplying unit configured to supply the premix agent to the developing device.

9. The premix agent according to claim 8, wherein surfaces of particles of the carrier are coated with a silicone resin.

10. The premix agent according to claim 8, wherein the toner contains base particles, and each of the base particles further contains, as the release promoter, a microcrystalline wax which is formed of a C20-C80 hydrocarbon containing a linear hydrocarbon in an amount of 55% by mass to 70% by mass and has an endothermic peak temperature of 65° C. to 90° C. measured through differential scanning calorimetry.

11. The premix agent according to claim 10, wherein an amount of the release promoter contained in the base particles is 1% by mass to 20% by mass.

12. The premix agent according to claim 8, wherein the crystalline polyester resin has an endothermic peak temperature of 50° C. to 150° C. measured through differential scanning calorimetry.

13. The premix agent according to claim 8, wherein the toner has a volume average particle diameter of 3.0 μm to 6.0 μm.

14. The premix agent according to claim 8, wherein a ratio of a volume average particle diameter of the toner to a number average particle diameter of the toner is 1.05 to 1.25.

15. An agent container comprising:
the premix agent according to claim 8,
wherein the agent container is detachably mounted to a main body of an image forming apparatus which comprises:
a latent image bearing member,
a developing device for developing a latent image on the latent image bearing member with a developer containing the toner and the carrier,
the agent container, and
an agent supplying unit configured to supply the premix agent contained in the agent container to the developing device.

16. The agent container according to claim 15, wherein the toner contains base particles, and each of the base particles further contains, as the release promoter, a microcrystalline wax which is formed of a C20-C80 hydrocarbon containing a linear hydrocarbon in an amount of 55% by mass to 70% by mass and has an endothermic peak temperature of 65° C. to 90° C. measured through differential scanning calorimetry.

17. The agent container according to claim 16, wherein an amount of the release promoter contained in the base particles is 1% by mass to 20% by mass.

18. The agent container according to claim 15, wherein the crystalline polyester resin has an endothermic peak temperature of 50° C. to 150° C. measured through differential scanning calorimetry.

19. The agent container according to claim 15, wherein the toner has a volume average particle diameter of 3.0 μm to 6.0 μm.

20. The agent container according to claim 15, wherein a ratio of a volume average particle diameter of the toner to a number average particle diameter of the toner is 1.05 to 1.25.
